(19) United States
(12) Patent Application Publication
(10) Pub. No.: US 2025/0158763 A1
(43) Pub. Date: May 15, 2025

(54) SEMI-STATIC SWITCHING FOR DYNAMIC SUBCHANNEL OPERATION (DSO)

(71) Applicant: QUALCOMM Incorporated, San Diego, CA (US)

(72) Inventors: Gaurang NAIK, San Diego, CA (US); Ahmed Ragab ELSHERIF, San Jose, CA (US); George CHERIAN, San Diego, CA (US); Alfred ASTERJADHI, San Diego, CA (US); Abhishek Pramod PATIL, San Diego, CA (US); Sai Yiu Duncan HO, San Diego, CA (US)

(21) Appl. No.: 18/938,055

(22) Filed: Nov. 5, 2024

Related U.S. Application Data
(60) Provisional application No. 63/598,537, filed on Nov. 13, 2023.

(51) Int. Cl. H04L 5/00; H04L 1/00

(52) U.S. Cl. CPC H04L 5/0046; H04L 5/0048; H04L 1/0057; H04L 5/0055

(57) ABSTRACT

This disclosure provides methods, components, devices, and systems for semi-static switching for dynamic subchannel operation (DSO). Some aspects more specifically relate to trigger-based switching for DSO sessions. In some implementations, an access point (AP) may transmit a control frame indicating one or more frequency resources for a DSO session at a wireless station (STA), the indicated frequency resources included in one or more secondary subchannels. The control frame may be an example of a DSO announcement frame, a null data packet (NDP) announcement frame, an enhanced multi-STA block acknowledgment (eMBA) frame, or a block acknowledgment request (BAR) frame. The STA may switch to the one or more secondary subchannels for communications during the DSO session and may remain communicating via the secondary subchannels until detecting a trigger (for example, a time-based or frame-based trigger) to deactivate the DSO session and switch back to the primary subchannel for communications.

### PRIORITY INFORMATION

The present Application for Patent claims priority under 35 U.S.C. § 119 to U.S. Provisional Patent Application No. 63/598,537 by Naik et al., filed Nov. 13, 2023, and entitled “SEMI-STATIC SWITCHING FOR DYNAMIC SUBCHANNEL OPERATION (DSO),” which is assigned to the assignee hereof and hereby expressly incorporated by reference herein.

### TECHNICAL FIELD

This disclosure relates to wireless communication and, more specifically, to semi-static switching for dynamic subchannel operation (DSO).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, an AP supports a relatively wider bandwidth than one or more STAs communicating with the AP. If the AP communicates with STAs that fail to support wideband signaling (for example, signaling via the full bandwidth supported by the AP), a portion of the AP's operational bandwidth may be unused during the communications, resulting in relatively poor spectral efficiency for the WLAN. Additionally, switching between subchannels may involve communicating multiple frames between an AP and a STA, resulting in significant processing and signaling overhead if the STA frequently switches subchannels for communication.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a non-access point (AP) station (STA). The non-AP STA may include a processing system that includes processor circuitry and memory circuitry that stores code. The processing system may be configured to cause the non-AP STA to receive, via a primary subchannel associated with an AP STA, a first frame that indicates one or more frequency resources for a dynamic subchannel operation (DSO) session of the non-AP STA, the one or more frequency resources included in at least one secondary subchannel associated with the AP STA, communicate via the one or more frequency resources for a set of multiple transmission opportunities (TxOPs) in accordance with an activation of the DSO session based on the first frame, and communicate via the primary subchannel in accordance with a deactivation of the DSO session based on a time-based trigger, a frame-based trigger, or both.

Another innovative aspect of the subject matter described in this disclosure can be implemented in a method for wireless communications by a non-AP STA. The method may include receiving, via a primary subchannel associated with an AP STA, a first frame that indicates one or more frequency resources for a DSO session of the non-AP STA, the one or more frequency resources included in at least one secondary subchannel associated with the AP STA, communicating via the one or more frequency resources for a set of multiple TxOPs in accordance with an activation of the DSO session based on the first frame, and communicating via the primary subchannel in accordance with a deactivation of the DSO session based on a time-based trigger, a frame-based trigger, or both.

Another innovative aspect of the subject matter described in this disclosure can be implemented in another non-AP STA for wireless communications. The non-AP STA may include means for receiving, via a primary subchannel associated with an AP STA, a first frame that indicates one or more frequency resources for a DSO session of the non-AP STA, the one or more frequency resources included in at least one secondary subchannel associated with the AP STA, means for communicating via the one or more frequency resources for a set of multiple TxOPs in accordance with an activation of the DSO session based on the first frame, and means for communicating via the primary subchannel in accordance with a deactivation of the DSO session based on a time-based trigger, a frame-based trigger, or both.

Another innovative aspect of the subject matter described in this disclosure can be implemented in a non-transitory computer-readable medium storing code for wireless communications. The code may include instructions executable by a processor to receive, via a primary subchannel associated with an AP STA, a first frame that indicates one or more frequency resources for a DSO session of the non-AP STA, the one or more frequency resources included in at least one secondary subchannel associated with the AP STA, communicate via the one or more frequency resources for a set of multiple TxOPs in accordance with an activation of the DSO session based on the first frame, and communicate via the primary subchannel in accordance with a deactivation of the DSO session based on a time-based trigger, a frame-based trigger, or both.

Another innovative aspect of the subject matter described in this disclosure can be implemented in an AP STA. The AP STA may include a processing system that includes processor circuitry and memory circuitry that stores code. The processing system may be configured to cause the AP STA to transmit, via a primary subchannel of the AP STA, a first frame that indicates one or more frequency resources for a DSO session of a non-AP STA, the one or more frequency resources included in at least one secondary subchannel of the AP STA, communicate with the non-AP STA via the one or more frequency resources for a set of multiple TxOPs in accordance with an activation of the DSO session at the non-AP STA based on the first frame, and communicate with the non-AP STA via the primary subchannel in accordance with a deactivation of the DSO session at the non-AP STA based on a time-based trigger, a frame-based trigger, or both.

Another innovative aspect of the subject matter described in this disclosure can be implemented in a method for wireless communications by an AP STA. The method may include transmitting, via a primary subchannel of the AP STA, a first frame that indicates one or more frequency resources for a DSO session of a non-AP STA, the one or more frequency resources included in at least one secondary subchannel of the AP STA, communicating with the non-AP STA via the one or more frequency resources for a set of multiple TxOPs in accordance with an activation of the DSO session at the non-AP STA based on the first frame, and communicating with the non-AP STA via the primary subchannel in accordance with a deactivation of the DSO session at the non-AP STA based on a time-based trigger, a frame-based trigger, or both.

Another innovative aspect of the subject matter described in this disclosure can be implemented in another AP STA for wireless communications. The AP STA may include means for transmitting, via a primary subchannel of the AP STA, a first frame that indicates one or more frequency resources for a DSO session of a non-AP STA, the one or more frequency resources included in at least one secondary subchannel of the AP STA, means for communicating with the non-AP STA via the one or more frequency resources for a set of multiple TxOPs in accordance with an activation of the DSO session at the non-AP STA based on the first frame, and means for communicating with the non-AP STA via the primary subchannel in accordance with a deactivation of the DSO session at the non-AP STA based on a time-based trigger, a frame-based trigger, or both.

Another innovative aspect of the subject matter described in this disclosure can be implemented in a non-transitory computer-readable medium storing code for wireless communications. The code may include instructions executable by a processor to transmit, via a primary subchannel of the AP STA, a first frame that indicates one or more frequency resources for a DSO session of a non-AP STA, the one or more frequency resources included in at least one secondary subchannel of the AP STA, communicate with the non-AP STA via the one or more frequency resources for a set of multiple TxOPs in accordance with an activation of the DSO session at the non-AP STA based on the first frame, and communicate with the non-AP STA via the primary subchannel in accordance with a deactivation of the DSO session at the non-AP STA based on a time-based trigger, a frame-based trigger, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a wireless communications system that supports semi-static switching for dynamic subchannel operation (DSO).

FIG. 6 shows an example of DSO session activation and deactivation techniques that support semi-static switching.

FIG. 7 shows an example of a process flow that supports semi-static switching for DSO.

FIGS. 8 and 9 show block diagrams of example wireless communication devices that support semi-static switching for DSO.

FIG. 10 shows a flowchart illustrating an example process performable by or at a non-AP STA that supports semi-static switching for DSO.

FIG. 11 shows a flowchart illustrating an example process performable by or at an AP STA that supports semi-static switching for DSO.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system, or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, or 5G (New Radio (NR)) standards promulgated by the 3rd Generation Partnership Project (3GPP), among others. The described examples can be implemented in any device, system, or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO), and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to semi-static switching for dynamic subchannel operation (DSO). Some aspects more specifically relate to a wireless station (STA), which may be referred to as a non-AP STA, switching back to a primary subchannel from one or more secondary subchannels for DSO based on a trigger, such as a time-based trigger or a frame-based trigger. In some implementations, a wireless access point (AP), which may be referred to as an AP STA, may transmit a first frame (for example, a control frame) that indicates one or more frequency resources for a DSO session (for example, a frame exchange sequence or one or more frame exchanges) at the STA. The one or more frequency resources may be included in at least one secondary subchannel of the AP. The control frame may be an example of a DSO announcement frame, a DSO initial control frame (ICF), a null data packet (NDP) announcement frame, a block acknowledgment request (BAR) frame, an extended multi-STA block acknowledgment (eMBA) frame, or some combination of these or other frames configured to indicate the frequency resources for the STA to perform DSO. The STA may activate the DSO session and switch to the indicated frequency resources for DSO. In some implementations, the AP may solicit a response frame from the STA to confirm that the STA switched to the assigned frequency resources for DSO. In some other implementations, the AP may refrain from soliciting a confirmation from the STA. The STA and AP may exchange frames via the one or more frequency resources corresponding to the one or more secondary subchannels. In some implementations, the STA may continue operating on the one or more secondary subchannels for one or more transmission opportunities (TxOPs) until the STA detects a trigger to deactivate the DSO session and switch back to the primary subchannel. In some implementations, the STA may determine a time-based trigger to switch back to the primary subchannel. In some other implementations, the AP may transmit a frame acting as a frame-based trigger to cause the STA to switch back to the primary subchannel. The STA may fall back to communicating via the primary subchannel based on detecting a trigger configured for the STA.

Particular aspects of the subject matter described in this disclosure can be implemented to realize one or more of the following potential advantages. In some implementations, by semi-statically switching for DSO, the described techniques may allow a STA to reduce a signaling and processing overhead associated with DSO communications. For example, the STA may communicate via one or more secondary subchannels for DSO for multiple TxOPs without using multiple DSO initial frame exchanges, multiple switching operations, or both to improve signaling and processing overhead. Additionally, or alternatively, by supporting confirmation flexibility at the AP, the AP may improve reliability or efficiency based on one or more system parameters. For example, based on current link or system metrics, the AP may determine whether or not to solicit confirmation from the STA that the STA successfully switched to the one or more secondary subchannels. The AP may solicit confirmation to improve signaling reliability or may refrain from soliciting confirmation to improve a signaling overhead associated with DSO. In some implementations, by using a DSO announcement frame, a DSO ICF, an NDP announcement frame, a BAR frame, an eMBA frame, or some combination thereof to assign resources for DSO, the AP may support improved flexibility and efficient signaling reuse for DSO procedures.

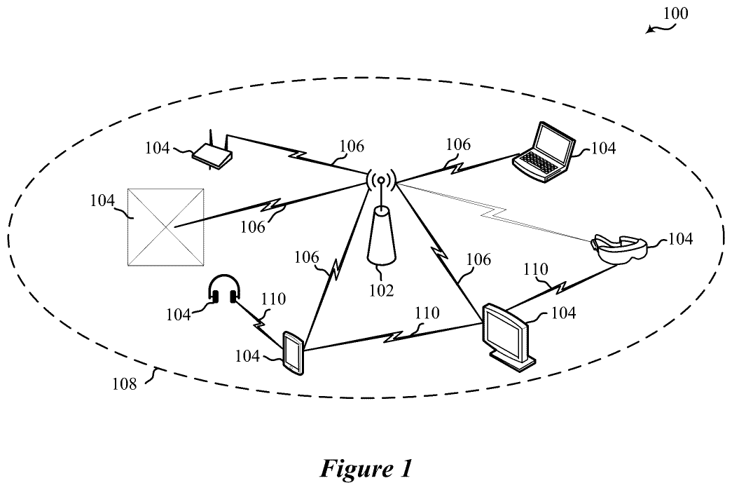

FIG. 1 shows a pictorial diagram of an example wireless communication network 100. According to some aspects, the wireless communication network 100 can be an example of a WLAN such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11 bf, and 802.11bn). In some other implementations, the wireless communication network 100 can be an example of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some implementations, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other implementations, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other implementations in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other implementations, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

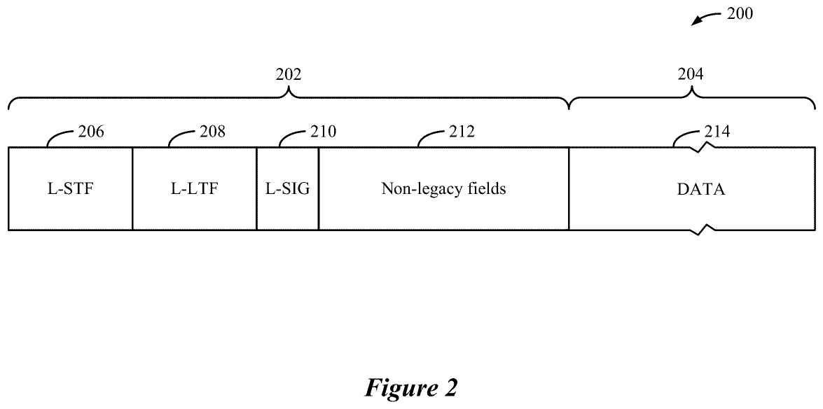

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

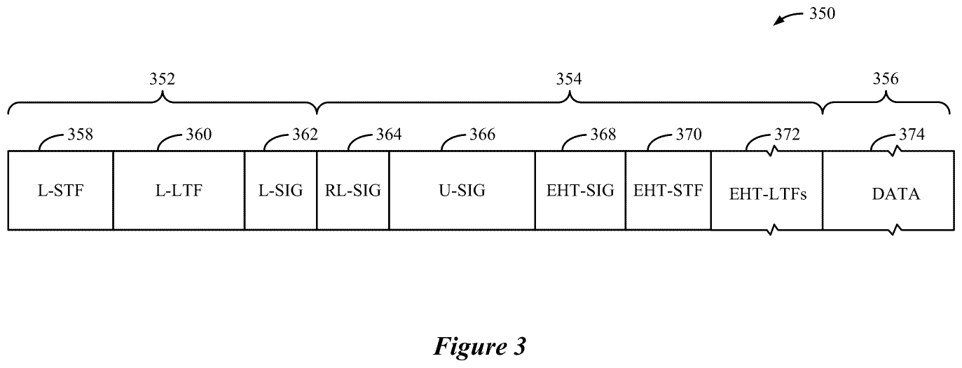

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

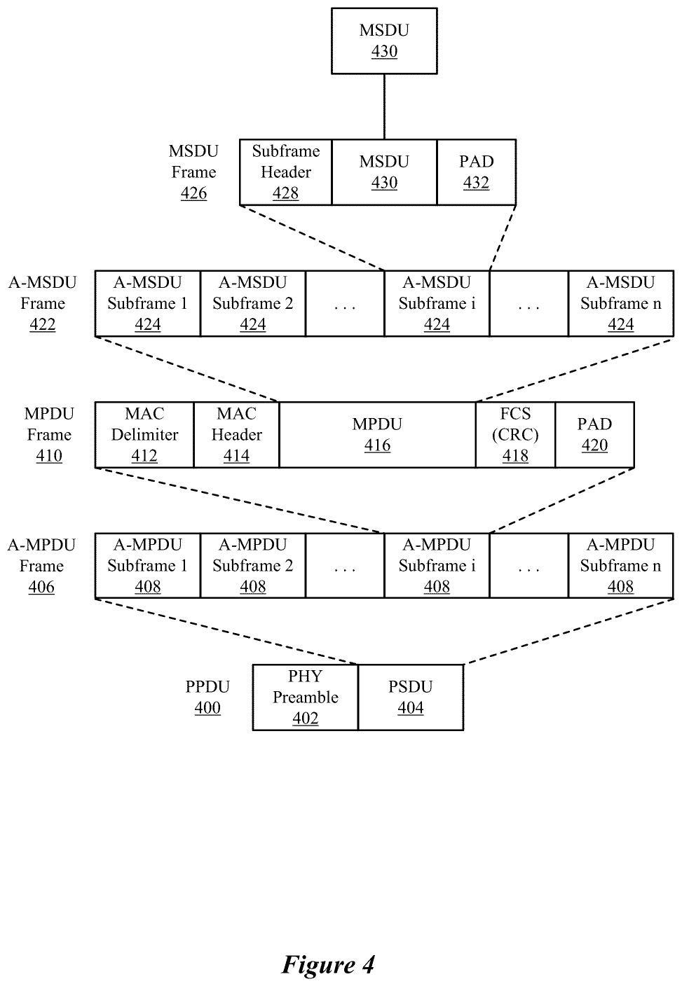

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MPDUs 416. For example, each PSDU 404 may carry an A-MPDU 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with (such as an example of or otherwise referred to as) an MSDU frame 426 and may contain a corresponding MSDU 430 preceded by a subframe header 428 and in some implementations followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective AIDs and may assign each AID (and thus each STA 104) one or more RUs that can be used to send UL traffic to the AP 102. The AP also may designate one or more random access (RA) RUs that unscheduled STAs 104 may contend for.

Some wireless communication devices (including both APs and STAs such as, for example, AP 102 and STAs 104 described with reference to FIG. 1) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some implementations, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHz, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and quality of service (QoS) characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some implementations, the parallel wireless communication links may support synchronized transmissions. In some other implementations, or during some other durations of time, transmissions over the links may be parallel, but not be synchronized or concurrent. In some implementations or durations of time, two or more of the links may be used for communications between the wireless communication devices in the same direction (such as all uplink or all downlink). In some other implementations or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some implementations, MLA may be packet-based. For packet-based aggregation, frames of a single traffic flow (such as all traffic associated with a given traffic identifier (TID)) may be sent concurrently across multiple communication links. In some other implementations, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other implementations, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some implementations in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other implementations in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz, or more. The use of dRUs may be limited to uplink communications because benefits to addressing PSD limits may only be present for uplink communications.

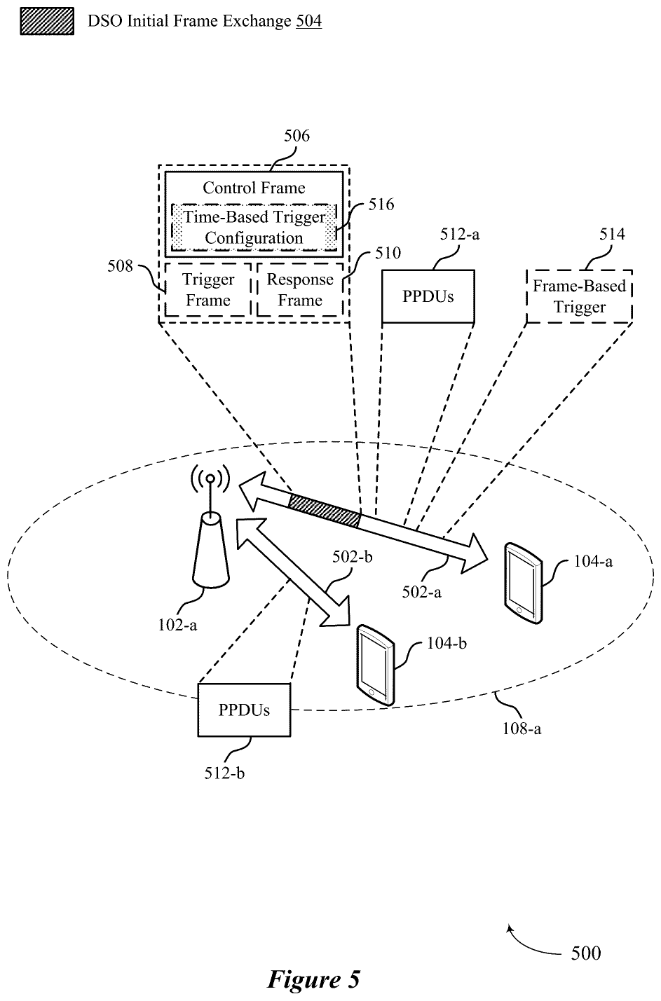

FIG. 5 shows an example of a wireless communications system 500 that supports semi-static switching for DSO. The wireless communications system 500 may be an example of a wireless communication network 100 as described with reference to FIG. 1. The wireless communications system 500 may include an AP 102-a, which may be an example or a component of an AP STA, an AP MLD, or an AP 102 as described herein with reference to FIG. 1. The wireless communications system 500 may additionally include a STA 104-a and a STA 104-b, which may be examples or components of non-AP STAs, non-AP MLDs, or STAs 104 as described herein with reference to FIG. 1. The AP 102-a may serve a coverage area 108-a and may communicate with the STA 104-a, the STA 104-b, or both using PDUs, such as PPDUs including one or more MPDUs, as described herein with reference to FIGS. 2-4. The wireless communications system 500 may support signaling for DSO. For example, the STA 104-a may communicate link-specific DSO information with the AP 102-a for a link 502-a (for example, a link 502-a between the STA 104-a and the AP 102-a), while the STA 104-b may communicate link-specific DSO information with the AP 102-a for a link 502-b. In some aspects, the wireless communications system 500 may support semi-static switching for DSO, where a STA 104-a may switch to a secondary subchannel for DSO communications and may remain communicating via the secondary subchannel for multiple TxOPs until detecting a trigger (for example, a time-based trigger according to a time-based trigger configuration 516 or a frame-based trigger 514) to switch back to a primary channel.

In some implementations, to support DSO, the STA 104-a may support one or more capabilities. The STA 104-a may indicate, to the AP 102-a, the one or more capabilities using capability signaling (for example, to signal static capabilities of the STA 104-a). The STA 104-a may be an example of a narrowband STA, such that the STA 104-a fails to support communications across a full operating bandwidth of the AP 102-a. That is, a first operating bandwidth of the narrowband STA 104-a may be relatively narrower than a second operating bandwidth of the AP 102-a (for example, for the specific link 502-a). To enable DSO, the STA 104-a may be capable of switching a radio of the STA 104-a dynamically from a primary channel (for example, a primary subchannel) to at least one non-primary channel (for example, a secondary subchannel). Additionally, or alternatively, to enable DSO, the STA 104-a may be capable of receiving frames sent in a single PPDU on one or more non-primary channels. For example, the AP 102-a may transmit a single PPDU that spans the primary channel (for example, primary subchannel) and one or more non-primary channels (for example, secondary subchannels). The STA 104-a may support multi-user OFDMA, frequency domain aggregate PPDU (FD A-PPDU), or both to receive the frames via a non-primary channel. In some implementations, the STA 104-a may park its radio on (for example, default to receiving via) the primary channel, and the STA 104-a may switch to communicating via a non-primary channel if the AP 102-a signals the STA 104-a to switch to the non-primary channel, for example, in a DSO mode.

DSO may be a link-specific feature. For example, the AP 102-a and the STA 104-a may be MLDs, where each MLD may support DSO on one or more links of a multi-link (ML) setup. In some implementations, an MLD (for example, the AP 102-a, the STA 104-a) may support DSO on a first subset of links and may refrain from supporting—or otherwise fail to support—DSO on a second subset of links. DSO support may be relatively more beneficial for links that support relatively high bandwidths (for example, to efficiently use the resources of the relatively high bandwidth). For example, the AP 102-a, which may be an example of an AP MLD, may support three links, including a 2.4 gigahertz (GHz) frequency band link, a 5 GHz frequency band link, and a 6 GHz frequency band link, respectively corresponding to a 20 MHz bandwidth, an 80 MHz bandwidth, and a 160 MHz bandwidth. DSO support may provide relatively greater resource usage gains for the 6 GHz frequency band link than the 2.4 GHz frequency band link. Accordingly, in some implementations, the AP 102-a may support DSO for the 6 GHz frequency band link but not the 2.4 GHz frequency band link.

The STA 104-a may transmit capability signaling to indicate that the STA 104-a supports DSO (for example, on one or more links). In some implementations, support for DSO may be based on the bandwidth of a link, the frequency band of the link, or both. As a first example, if the operating bandwidth for a link for the AP 102-a is 160 MHz or greater, the AP 102-a may support DSO for the link. If the operating bandwidth for the link for the AP 102-a is less than 160 MHz, the AP 102-a may not support (or may refrain from supporting) DSO for the link. Accordingly, the AP 102-a may indicate “DSO supported” for one or more links based on the bandwidths of the links. As a second example, DSO may be disallowed if a link is in the 2.4 GHz band, optional if the link is in the 5 GHz band, and allowed if the link is in the 6 GHz band. In some implementations, STAs (for example, AP STAs, non-AP STAs) may support other rules for determining DSO support based on link bandwidths, frequency bands, or other link parameters.

The AP 102-a and the STA 104-a may communicate a DSO initial frame exchange 504 to cause the STA 104-a to enter a DSO frame exchange sequence, which may be referred to as a DSO session. For example, the AP 102-a may indicate one or more frequency resources corresponding to one or more secondary subchannels for DSO, and the STA 104-a may switch to communicating via the one or more frequency resources corresponding to the one or more secondary subchannels for the link 502-a.

In some implementations, the STA 104-a may dynamically switch for the DSO session. For example, the STA 104-a may dynamically switch to communicate via the one or more secondary subchannels for a TxOP and may automatically switch back to communicating via the primary subchannel after the TxOP (for example, after a frame exchange with the AP 102-a during the TxOP). However, in some implementations, such dynamic switching may result in inefficient signaling for the DSO initial frame exchange 504. For example, if a duration of data frames exchanged via DSO is relatively small, the overhead associated with the DSO initial frame exchange 504 and the switchback to the primary subchannel may be comparable to the overhead of the data frames exchanged. The DSO initial frame exchange 504 may include a control frame 506 (for example, a DSO announcement frame or other control frame), padding, a trigger frame 508 (for example, a buffer status report poll (BSRP) trigger frame or another frame triggering a response), a response frame 510 (for example, a buffer status response (BSR) frame or other frame in response to the trigger frame 508), a short interframe spacing (SIFS) duration, or any combination thereof. The DSO initial frame exchange 504 and switching processes performed by the STA 104-a for DSO dynamic switching may involve a relatively high proportion of signaling and processing overhead at the STA 104-a as compared to the data frame exchange during DSO. For example, a first switching delay to switch from the primary subchannel to a secondary subchannel for DSO may be approximately 64 microseconds (μs) (or up to 500 μs), a duration (for example, overhead) of the DSO initial frame exchange 504 may be approximately 200 μs, and a second switching delay to switch back from the secondary subchannel for DSO to the primary subchannel may be approximately 100 μs. If a duration of the data frame exchanges during DSO is approximately 1 millisecond (ms), the overhead of the DSO initial frame exchange 504 and switching processes may be approximately 23%, which may significantly affect the efficiency of the STA 104-a. If the duration of the exchanged data frames increases, the relative overhead of the DSO initial frame exchange 504 and switching processes may decrease. However, the overhead may still be approximately 5%, which may reduce an application layer throughput (for example, for high throughput applications).

Such inefficiencies may be based on the dynamic switching aspect for DSO, where the STA 104-a communicates the DSO initial frame exchange 504 and performs the switching to and from the secondary subchannel(s) per-TxOP (for example, per frame exchange sequence) for DSO. To reduce the signaling overhead and improve the efficiency associated with DSO, the STA 104-a may support semi-static switching for DSO sessions. For example, the STA 104-a may support a semi-static mode for DSO, where the STA 104-a may remain communicating via the secondary subchannel(s) for DSO after the first TxOP (for example, after the frame exchange sequence). The AP 102-a may schedule subsequent communications (for example, subsequent frames) with the STA 104-a in the secondary subchannel(s) for DSO, for example, without performing an additional DSO initial frame exchange 504 or switching. Accordingly, the STA 104-a may continue to communicate via the secondary subchannel(s) for DSO and may reduce the signaling and processing overhead associated with switching to the secondary subchannel(s). In some aspects, the wireless communications system 500 may support a dynamic mode for DSO (for example, where the STA 104-a automatically switches back to the primary subchannel after a first TxOP), a semi-static mode for DSO (for example, where the STA 104-a remains on the secondary subchannel(s) until a trigger indicates for the STA 104-a to switch back to the primary subchannel), or both.

The STA 104-a (for example, a non-AP STA) may operate on the primary subchannel of an operating bandwidth by default. For example, the STA 104-a may monitor the primary 20 MHz subchannel (pri20). The AP 102-a may transmit a message as part of a DSO initial frame exchange 504 (for example, a control frame 506) indicating for the STA 104-a to switch to a secondary subchannel. The DSO initial frame exchange 504 for the semi-static mode for DSO may be similar to or the same as the DSO initial frame exchange 504 for the dynamic mode for DSO. Additionally, or alternatively, the operations for switching to the secondary subchannel for the semi-static DSO mode may be similar to or the same as the operations for switching to the secondary subchannel for the dynamic DSO mode. In some implementations, the DSO initial frame exchange 504 may include an announcement frame (for example, the control frame 506) followed by a trigger frame 508 (for example, a BSRP trigger frame) to confirm that the STA 104-a switched to the secondary subchannel. The AP 102-a may transmit both the announcement frame and the trigger frame 508, and the STA 104-a may transmit a response frame 510 via the secondary subchannel to confirm that the STA 104-a switched to the secondary subchannel. In some other implementations, the DSO initial frame exchange 504 may not include an announcement frame. Instead, the DSO initial frame exchange 504 may include a control frame 506 (for example, a DSO initial control frame (ICF)) that triggers a response from the STA 104-a. The AP 102-a may transmit the DSO ICF indicating the secondary subchannel for DSO for the STA 104-a, and the STA 104-a may transmit a response frame 510 via the secondary subchannel to confirm that the STA 104-a switched to the secondary subchannel.

The STA 104-a may continue to operate via the secondary subchannel after the STA 104-a and the AP 102-a exchange frames (for example, PPDUs 512-a) via the secondary subchannel (for example, during a TxOP). For example, the STA 104-a may refrain from automatically (for example, dynamically) switching back to the primary subchannel at the end of the frame exchange sequence. While the STA 104-a remains operating on the secondary subchannel, the AP 102-a may continue scheduling the STA 104-a for communications via the secondary subchannel. The STA 104-a may switch back to the primary subchannel based on a trigger. For example, the STA 104-a may switch back to the primary subchannel based on receiving a frame triggering the switch (for example, a frame-based trigger 514), at a time agreed to with the AP 102-a (for example, according to a time-based trigger configuration 516), or based on some other trigger. While the AP 102-a communicates PPDUs 512-a with the STA 104-a via the secondary subchannel (for example, while the STA 104-a operates in a DSO session), the AP 102-a may additionally communicate PPDUs 512-b with the STA 104-b via the primary subchannel to efficiently utilize the operating bandwidth of the AP 102-a.

The AP 102-a may assign frequency resources corresponding to one or more secondary subchannels for the semi-static DSO mode at the STA 104-a based on a preference of the STA 104-a. In some implementations, the STA 104-a may transmit a request for one or more secondary subchannels or corresponding frequency resources using a bitmap. Additionally, or alternatively, the AP 102-a may announce one or more anchor channels (for example, temporary primary channels over which the STA 104-a may monitor for scheduling signaling when the STA 104-a is not operating on the primary subchannel), and the STA 104-a may select a subset of the anchor channels and may indicate the selection to the AP 102-a. The AP 102-a may assign the frequency resources for DSO to the STA 104-a based on the subset of anchor channels selected by the STA 104-a. In some other implementations, the STA 104-a may select one or more anchor channels to use for communications independent of, and transparent to, the AP 102-a.

The STA 104-a and the AP 102-a may communicate via the secondary subchannel (for example, via one or more indicated frequency resources included in at least one secondary subchannel of the operating bandwidth) during the active DSO session. The STA 104-a may activate the DSO session based on switching to the secondary subchannel for DSO communications. The AP 102-a may transmit frames to the STA 104-a via the secondary subchannel using an MU PPDU format for downlink. The STA 104-a may transmit frames to the AP 102-a via the secondary subchannel using a trigger-based (TB) PPDU format for uplink. In some implementations, the PPDUs 512-a may be HE, EHT, or UHR variants. The AP 102-a may schedule the STA 104-a resources for communications within the secondary subchannel until the STA 104-a switches back to the primary subchannel. In some implementations, the AP 102-a may refrain from transmitting additional DSO announcement frames to the STA 104-a while the STA 104-a operates via the secondary subchannel during the active DSO session. In some other implementations, the AP 102-a may transmit an additional DSO announcement frame to update one or more parameters for the DSO session (for example, switch the STA 104-a to one or more different secondary subchannels for DSO without switching the STA 104-a back to the primary subchannel).

In some implementations, an OBSS device (for example, an OBSS STA or AP) may occupy the primary subchannel. If the STA 104-a operates via one or more secondary subchannels including at least one opportunistic primary (O-Primary) subchannel (for example, an O-Primary 20 MHz channel), the AP 102-a and the STA 104-a may communicate via the O-Primary subchannel while the OBSS device communicates via the primary subchannel. For example, the AP 102-a may transmit a frame to the STA 104-a via the secondary subchannels including the O-Primary subchannel if the OBSS device is occupying the primary subchannel. The AP 102-a may transmit the frame in any PPDU format because the transmission may not be accompanied by a transmission (for example, a duplicate transmission) via the OBSS-occupied primary subchannel. In some aspects, the AP 102-a may initiate the frame exchange without using a multi-primary ICF. Additionally, or alternatively, if the STA 104-a detects the OBSS device occupying the primary subchannel, the STA 104-a may contend for the one or more secondary subchannels including the O-Primary subchannel and may transmit an uplink frame via the one or more secondary subchannels. In some implementations, the STA 104-a may detect the OBSS device if the STA 104-a includes an auxiliary (AUX) radio that monitors the primary subchannel. In some aspects, the STA 104-a may initiate a TxOP for transmitting the uplink frame using a multi-primary ICF.

Additionally, or alternatively, the AP 102-a may transmit group-addressed frames in a duplicate PPDU format, for example, across the AP's operating bandwidth. The STA 104-a may receive one or more of the group-addressed frames via the secondary subchannel without switching back to the primary subchannel based on the duplicate PPDU format (for example, the non-high throughput (HT) duplicate PPDU format or the UHR duplicate PPDU format). In some aspects, the group-addressed frames may include beacons.

The STA 104-a operating on the one or more secondary subchannels for DSO may monitor an anchor channel (for example, a temporary primary subchannel of the one or more secondary subchannels) for incoming PPDUs 512-a from the AP 102-a. The STA 104-a may refrain from dynamically puncturing (for example, puncturing on a per-TxOP level by indicating a puncturing pattern in a PPDU) the anchor channel while the STA 104-a is operating on the one or more secondary subchannels to support the STA 104-a monitoring the anchor channel. In some implementations, the AP 102-a may support static puncturing of an anchor channel. For example, the AP 102-a may statically puncture one or more subchannels (or at least a portion of a secondary subchannel) during the operation of the AP's BSS. If the AP 102-a statically punctures the STA's anchor channel, the STA 104-a may automatically (for example, without explicit signaling) switch to the primary subchannel. Alternatively, the AP 102-a may notify the STA 104-a of another supported anchor channel associated with the one or more secondary subchannels for DSO for the STA 104-a, and the STA 104-a may switch to another anchor channel associated with the one or more secondary subchannels (for example, instead of falling back to the primary subchannel). In some implementations, the AP 102-a may notify the STA 104-a of the new anchor channel in the same message (for example, frame) that announces the static puncturing pattern.

The STA 104-a semi-statically communicating via the secondary subchannel for an active DSO session may switch back to the primary subchannel based on a trigger. In some implementations, the trigger may be an example of a time-based trigger, where the STA 104-a may switch back to the primary subchannel at a specific time. In some implementations, the AP 102-a may specify a duration for the STA 104-a to communicate via the secondary subchannel (for example, a duration for the DSO session). At the end of the duration (for example, based on an expiration of the duration, an expiration of a timer tracking the duration), the STA 104-a may deactivate the DSO session and may switch back to the primary subchannel. The AP 102-a may indicate the duration (for example, a time-based trigger configuration 516) in the control frame 506, such as a DSO announcement frame, a DSO ICF, or another control frame 506 operating as a DSO announcement frame. Additionally, or alternatively, the AP 102-a may indicate the duration in a management frame (for example, a beacon frame) to multiple STAs 104, such that multiple STAs 104 may be configured with the same duration for semi-static DSO sessions.

In some other implementations, the AP 102-a may specify a TSF value for the STA 104-a to switch back to the primary subchannel. For example, the AP 102-a may indicate the TSF value (or another indication of a timestamp) in the control frame 506, such as a DSO announcement frame, a DSO ICF, or another control frame 506 operating as a DSO announcement frame. The TSF value may be specific to the STA 104-a. The STA 104-a may deactivate the DSO session and switch back to the primary subchannel at the time indicated by the TSF value.

In yet some other implementations, the time-based trigger may be based on an epoch, which may be an example of a periodic or otherwise scheduled time for one or more operations. The STA 104-a may store the epoch as a time-based trigger for switching back to the primary subchannel, or the AP 102-a may configure the STA 104-a with the epoch (for example, via a time-based trigger configuration 516). In some implementations, the STA 104-a may deactivate the DSO session and switch back to the primary subchannel at (or based on) a TBTT. The STA 104-a may receive a beacon frame via the primary subchannel during the TBTT based on switching back for the TBTT. Additionally, or alternatively, the STA 104-a may deactivate the DSO session and switch back to the primary subchannel at (or based on) a TBTT for a delivery traffic indication message (DTIM) beacon. The STA 104-a may receive the DTIM beacon frame via the primary subchannel during the TBTT based on switching back for the TBTT. Additionally, or alternatively, the STA 104-a may deactivate the DSO session and switch back to the primary subchannel at (or based on) a target wake time (TWT) service period (SP), such as a restricted TWT SP. For example, the STA 104-a may switch back to the primary channel to communicate with the AP 102-a during the TWT SP based on negotiating the TWT SP with the AP 102-a for a frame exchange.

In some implementations, the AP 102-a may refrain from specifying a time for the STA 104-a to switch back to the primary subchannel. For example, the AP 102-a may include a default value (for example, 0) or another value in a control frame 506, such as a DSO announcement frame, a DSO ICF, or another control frame 506 operating as a DSO announcement frame. Such a value may indicate for the STA 104-a to instead switch back based on a frame-based trigger 514 or may indicate for the STA 104-a to automatically switch back to the primary subchannel after the first TxOP (for example, after a frame exchange sequence, such as for dynamic switching DSO).

In some implementations, the STA 104-a may deactivate the DSO session and switch back to the primary subchannel based on receiving a frame indicating a frame-based trigger 514. For example, the AP 102-a may transmit the frame (for example, via the secondary subchannel) requesting the STA 104-a to switch back to the primary subchannel. In some implementations, the frame may be an example of a DSO announcement frame, a DSO ICF, or a trigger frame 508 assigning the STA 104-a one or more frequency resources included in the primary subchannel. For example, based on the resource assignment, the STA 104-a may switch back to the primary subchannel. In some implementations, the frame may indicate other resources. For example, the frame may assign the STA 104-a one or more frequency resources included in one or more different secondary subchannels. The STA 104-a may switch to the one or more different secondary subchannels (for example, maintain the same DSO session) based on receiving the frame.

In some implementations, the STA 104-a may support early switch back to the primary subchannel (for example, prior to a time-based trigger, prior to receiving a frame-based trigger 514). For example, the STA 104-a may determine to switch back to the primary subchannel prior to a time specified by the AP 102-a. The STA 104-a may switch back to the primary subchannel and may use a mechanism to notify the AP 102-a that the STA 104-a switched back to the primary subchannel. For example, after switching back, the STA 104-a may transmit a frame via the primary subchannel to indicate that the STA 104-a switched back to the primary subchannel. In some aspects, the STA 104-a may transmit a QoS null frame to the AP 102-a via the primary subchannel, and the AP 102-a may determine that the STA 104-a switched back to the primary subchannel (for example, switched back early) based on receiving the QoS null frame via the primary subchannel.

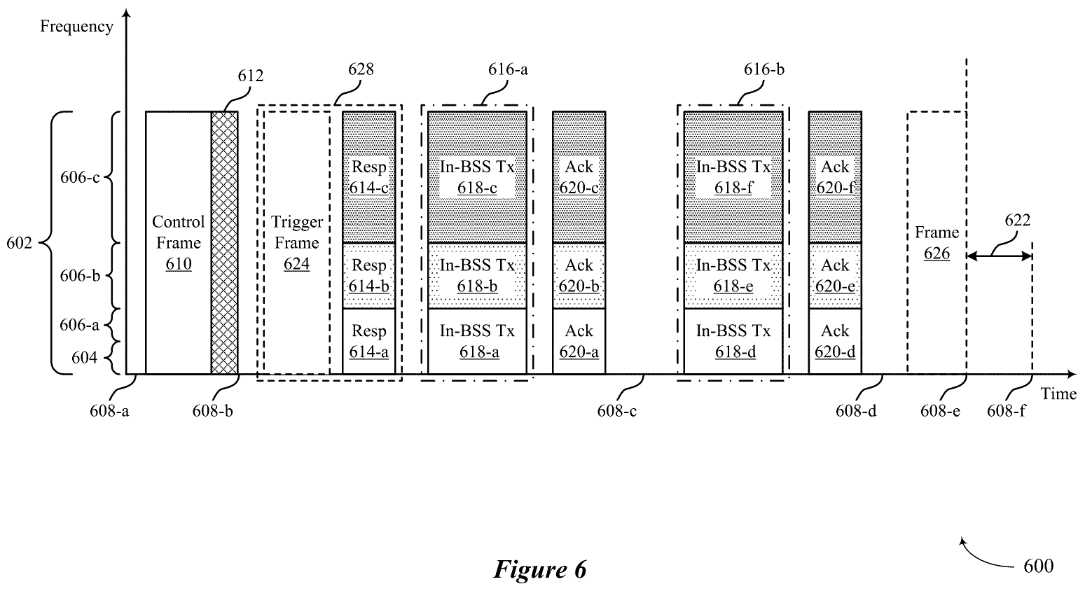

FIG. 6 shows an example of DSO session activation and deactivation techniques 600 that support semi-static switching for DSO. A wireless communication network 100 or a wireless communications system 500, as described with reference to FIGS. 1 and 5, may support the DSO session activation and deactivation techniques 600. For example, an AP 102 may communicate with multiple STAs 104 in accordance with the DSO session activation and deactivation techniques 600. For example, if the AP 102, one or more STAs 104, or both are operating in a DSO mode, the AP 102 and the one or more STAs 104 may communicate according to the DSO session activation and deactivation techniques 600 to support semi-statically switching subchannels to efficiently utilize the operating bandwidth 602 of the AP 102.

In some aspects, the operating bandwidth 602 of the AP 102 may include one or more subchannels, such as a primary subchannel 604 (for example, P20 spanning 20 MHz) and one or more secondary subchannels. In some implementations, the secondary subchannels may include a first secondary subchannel 606-a (for example, S20 spanning 20 MHz), a second secondary subchannel 606-b (for example, S40 spanning 40 MHz), and a third secondary subchannel 606-c (for example, S80 spanning 80 MHz). One or more STAs 104 may indicate support for switching to one or more of the secondary subchannels for DSO. For example, a first STA 104 may not indicate support for DSO, a second STA 104 may indicate support for the second secondary subchannel 606-b, and a third STA 104 may indicate support for the second secondary subchannel 606-b and the third secondary subchannel 606-c.

At time 608-a, the STAs 104 may communicate via the primary subchannel 604. For example, the STAs 104 may initially park on the primary subchannel 604. Based on an operating bandwidth for the STAs 104, one or more of the STAs 104 may further communicate via one or more secondary subchannels. For example, if the first STA 104 operates with a narrowband operating bandwidth of 40 MHz, the first STA 104 may communicate via the primary subchannel 604 and the first secondary subchannel 606-a, collectively spanning 40 MHz.

The AP 102 may transmit a control frame 610 to the STAs 104 assigning secondary subchannels to one or more of the STAs 104 for DSO. In some implementations, the control frame 610 may be based on the indicated secondary subchannels supported by the STAs 104. For example, the control frame 610 may assign the second secondary subchannel 606-b (for example, S40) to the second STA 104 and may assign the third secondary subchannel 606-c (for example, S80) to the third STA 104. In some implementations, the control frame 610 may assign one or more frequency resources to a STA 104 that includes a frequency portion or chunk that is relatively smaller than a full subchannel span. In some such examples, the STA 104 may determine to switch to a subchannel including the assigned one or more frequency resources. Additionally, or alternatively, the control frame 610 may assign frequency resources spanning multiple subchannels of the indicated subchannels, and the STA 104 may determine to switch to operating via the multiple subchannels based on the control frame 610. In some aspects, the control frame 610 may be an example of a non-HT DUP frame (for example, a trigger frame duplicated across multiple subchannels of the operating bandwidth 602), an MU-request to send (RTS) frame, or a DSO ICF. The control frame 610 may trigger the one or more STAs 104 to switch to the assigned secondary subchannels for DSO communications.

The AP 102 may support one or more types of control frames 610 for assigning the resources for DSO. For example, the AP 102 may support a DSO announcement frame (for example, a non-HT DUP frame not soliciting a response), a DSO ICF (for example, a non-HT DUP frame soliciting a response, such as a trigger frame), an NDP announcement frame, an eMBA frame, a BAR frame, or any combination thereof.

The AP 102 may communicate random (or semi-random) signaling as padding 612 signaling or may refrain from communicating during some padding 612 time that provides enough time for the STAs 104 to process the control frame 610 and switch to the assigned secondary subchannels. For example, the AP 102 may transmit the padding 612 signaling to occupy the channel while the STAs 104 switch operating frequencies. In some implementations, the length of the padding 612 may be based on STA capabilities. For example, if the second STA 104 can process the control frame 610 and tune to the assigned frequency (for example, the second secondary subchannel 606-b) in 16 μs and the third STA 104 can process the control frame 610 and tune to the assigned frequency (for example, the third secondary subchannel 606-c) in 32 μs, the AP 102 may set the length of the padding 612 (for example, the padding 612 signaling) to span at least 32 μs. The STAs 104 may report delay times for processing the control frame 610, switching to the assigned subchannel, or both to the AP 102 in capability signaling, operational mode signaling, or both, where the delay times may be STA-specific (for example, client-specific), link-specific, or both.

At time 608-b, the STAs 104 may complete switching to the assigned subchannels. For example, the first STA 104 may remain on the primary subchannel 604 and the first secondary subchannel 606-a, the second STA 104 may switch to the second secondary subchannel 606-b (for example, activating a DSO session for the second secondary subchannel 606-b), and the third STA 104 may switch to the third secondary subchannel 606-c (for example, activating a DSO session for the third secondary subchannel 606-c). In some implementations, to perform a confirmation process 628, the AP 102 may transmit a trigger frame 624 to confirm that the STAs 104 completed switching to the designed (for example, assigned) subchannels. The trigger frame 624 may be an example of a DSO confirmation frame, a BSRP trigger frame, a control frame, or any other trigger frame.

Once the STAs 104 have switched to the assigned subchannels, the STAs 104 may perform a clear channel assessment (CCA)-energy detection (ED) during a SIFS duration on the assigned subchannels (for example, the designated subchannels) to determine whether the assigned subchannels are available for communication. For example, the AP 102 may assign the second secondary subchannel 606-b to the second STA 104 based on the AP 102 failing to detect other communications occurring via the second secondary subchannel 606-b. However, the second STA 104 may switch to the second secondary subchannel 606-b and may perform the CCA-ED to detect if another device hidden from the AP 102 but detectable by the second STA 104 is transmitting via the second secondary subchannel 606-b.

In some implementations, the STAs 104 may transmit response frames to the AP 102 via the assigned subchannels based on determining that the assigned subchannels are available for communications (for example, based on the CCA-ED results). For example, the first STA 104 may transmit a response frame 614-a (for example, a clear to send (CTS) signal) via the primary subchannel 604 and the first secondary subchannel 606-a, the second STA 104 may transmit a response frame 614-b via the second secondary subchannel 606-b, and the third STA 104 may transmit a response frame 614-c via the third secondary subchannel 606-c. The response frames may indicate to the AP 102 that the STAs 104 are ready to communicate frames via the assigned subchannels in the DSO mode.

In some other implementations, to reduce signaling overhead, a STA 104 may refrain from transmitting a response frame to confirm the switch to the assigned subchannels is complete. For example, the confirmation process 628 may be optional. The AP 102 may perform the confirmation process 628 to improve reliability and coordination, or the AP 102 may refrain from performing the confirmation process 628 to improve the signaling overhead associated with switching to the secondary subchannels.

The AP 102 may exchange frames with the STAs 104 via the assigned subchannels (for example, in a single PPDU 616-a, such as an EHT MU PPDU) during a first TxOP. In some implementations, the AP 102 may exchange the frames based on receiving the response frames confirming that the STAs 104 successfully switched to the assigned subchannels. In some other implementations, the AP 102 may confirm the STAs 104 successfully switched to the assigned subchannels based on successfully exchanging the frames during the DSO session. The AP 102 may transmit a PPDU 616-a include multiple MPDUs corresponding to the different assigned subchannels. The first STA 104 may receive an in-BSS transmission 618-a via the primary subchannel 604 and the first secondary subchannel 606-a (for example, spanning 40 MHz), the second STA 104 may receive an in-BSS transmission 618-b via the second secondary subchannel 606-b (for example, spanning 40 MHz), and the third STA 104 may receive an in-BSS transmission 618-c via the third secondary subchannel 606-c (for example, spanning 80 MHz). Additionally, or alternatively, the STAs 104 may transmit PPDUs 616-a, MPDUs, or a combination thereof to the AP 102 via the assigned subchannels. The AP 102 and the STAs 104 may exchange more than one SIFS-separated PPDUs 616-a while operating via the assigned subchannels in the DSO mode.

In some implementations, based on exchanging one or more frames via the assigned subchannels, the AP 102, the STAs 104, or both may transmit acknowledgment frames to indicate successful reception of the one or more frames. For example, the first STA 104 may transmit an acknowledgment frame 620-a via the primary subchannel 604 and the first secondary subchannel 606-a, the second STA 104 may transmit an acknowledgment frame 620-b via the second secondary subchannel 606-b, and the third STA 104 may transmit an acknowledgment frame 620-c via the third secondary subchannel 606-c. The STAs 104 (for example, the second STA 104 and the third STA 104) may continue monitoring the assigned subchannels after communicating the acknowledgment frames to listen for any additional frames.

At time 608-c, the STAs 104 may remain on the assigned subchannels for DSO. For example, based on operating according to semi-static switching for DSO, the STAs 104 may not automatically fall back to the primary subchannel 604 after the exchange of frames (for example, a TxOP for the PPDU 616-a). Instead, the STAs 104 may fall back to the primary subchannel 604 based on a trigger (for example, a time-based trigger or a frame-based trigger).

In some implementations, a STA 104 may detect a trigger for falling back to the primary subchannel 604 during the first TxOP for DSO communications. The STA 104 may switch back to the primary subchannel 604 based on the trigger (for example, prior to completion of the first TxOP). In some other implementations, the STA 104 may detect the trigger after the first TxOP and may switch back to the primary subchannel 604 based on the trigger after the first TxOP (for example, similar to a STA 104 operating according to dynamic switching for DSO). In yet some other implementations, the STA 104 may detect the trigger after multiple TxOPs, where the STA 104 communicates via the assigned subchannel for multiple TxOPs during a same DSO session (for example, without additional DSO initial frame exchanges to improve the signaling overhead for DSO).

For example, the AP 102 may exchange additional frames with the STAs 104 via the assigned subchannels (for example, in a single PPDU 616-b) in a second TxOP. The AP 102 may exchange the frames without an additional DSO initial frame exchange procedure. The AP 102 may transmit a PPDU 616-b include multiple MPDUs corresponding to the different assigned subchannels. The first STA 104 may receive an in-BSS transmission 618-d via the primary subchannel 604 and the first secondary subchannel 606-a (for example, spanning 40 MHz), the second STA 104 may receive an in-BSS transmission 618-e via the second secondary subchannel 606-b (for example, spanning 40 MHz), and the third STA 104 may receive an in-BSS transmission 618-f via the third secondary subchannel 606-c (for example, spanning 80 MHz). Additionally, or alternatively, the STAs 104 may transmit PPDUs 616-b, MPDUs, or a combination thereof to the AP 102 via the assigned subchannels. In some implementations, the first STA 104 may transmit an acknowledgment frame 620-d via the primary subchannel 604 and the first secondary subchannel 606-a, the second STA 104 may transmit an acknowledgment frame 620-e via the second secondary subchannel 606-b, and the third STA 104 may transmit an acknowledgment frame 620-f via the third secondary subchannel 606-c. At time 608-d, the STAs 104 may continue operating on the assigned subchannels for DSO.

The STAs 104 may detect triggers to switch back to the primary subchannel 604. In some implementations, the AP 102 may transmit a frame 626 operating as a frame-based trigger to cause a STA 104 to deactivate the DSO session and switch back to the primary subchannel 604. Additionally, or alternatively, at time 608-e, a STA 104 may determine a time-based trigger and may deactivate the DSO session and switch back to the primary subchannel 604 based on the time-based trigger. For example, at time 608-e, the second STA 104 may initiate switching back from operating via the second secondary subchannel 606-b to operating via at least the primary subchannel 604 based on the time-based trigger, and the third STA 104 may initiate switching back from operating via the third secondary subchannel 606-c to operating via at least the primary subchannel 604 in response to receiving the frame 626 as a frame-based trigger. The second and third STAs 104 may switch back to the primary subchannel 604 at different times based on different triggers (for example, different frame-based triggers, different time-based triggers, different types of triggers). Additionally, or alternatively, the control frame 610 may indicate a time duration (for example, the additional timeout interval 622) for a STA 104 to remain operating via the assigned subchannel before switching back to the primary subchannel 604 in response to a trigger. In some implementations, the additional timeout interval 622 may include a switching delay for the STAs 104 to complete the switch back to the primary subchannel 604. At time 608-f, the STAs 104 may communicate via the primary subchannel 604 based on switching back to the primary subchannel 604 for PPDU communications.

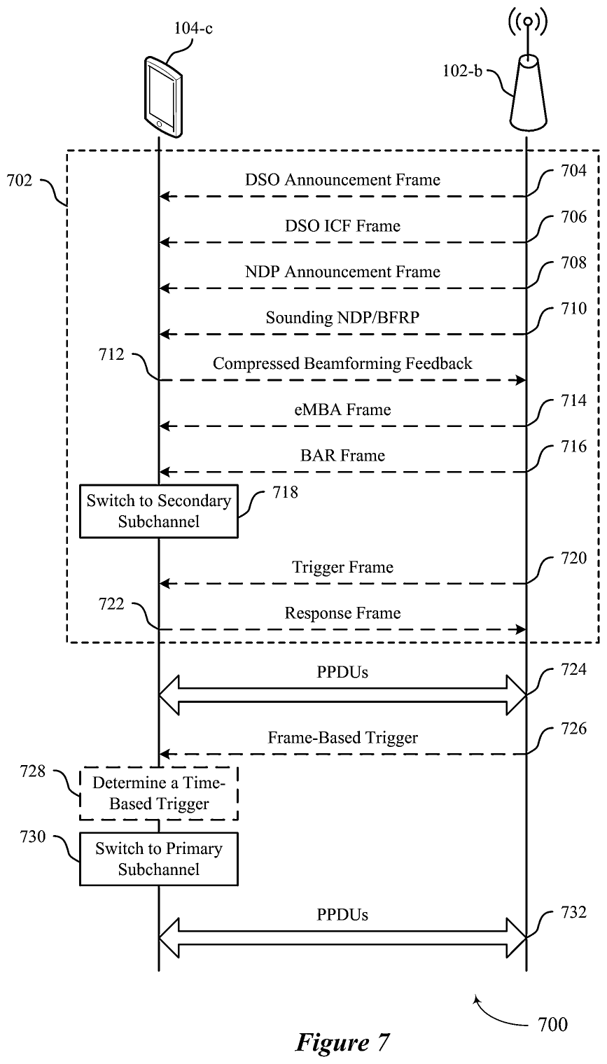

FIG. 7 shows an example of a process flow 700 that supports semi-static switching for DSO. The process flow 700 may implement, or be implemented by, aspects of the wireless communication network 100, the wireless communications system 500, or a combination thereof. For example, the process flow 700 may include a STA 104-c (for example, a non-AP STA) and an AP 102-b (for example, an AP STA), which may be examples of corresponding devices described herein with reference to FIGS. 1-6. In the following description of the process flow 700, the operations may be performed in a different order than the order shown. Specific operations also may be left out of the process flow 700, or other operations may be added to the process flow 700. Further, although some operations or signaling may be shown to occur at different times for discussion purposes, these operations may occur at the same time.

At 702, the AP 102-b and the STA 104-c may perform a DSO initial frame exchange to activate a DSO session at the STA 104-c. Activating the DSO session at the STA 104-c may involve the STA 104-c switching from communicating via a primary subchannel to communicating via a secondary subchannel. In some implementations, the DSO session may be an example of a dynamic session, where the STA 104-c may switch to the secondary subchannel for a single TxOP and may switch back to the primary subchannel after the single TxOP. In some other implementations, the DSO session may be an example of a semi-static DSO session, where the STA 104-c may switch to the secondary subchannel for one or more TxOPs (for example, multiple TxOPs) and may switch back to the primary subchannel based on a time-based trigger, a frame-based trigger, or both.

The DSO initial frame exchange may indicate, to the STA 104-c, one or more frequency resources to use during the active DSO session (for example, where the one or more frequency resources are included within one or more secondary subchannels of an operating bandwidth). The DSO initial frame exchange also may switch the STA 104-c to communicate via the one or more secondary subchannels. In some implementations, the DSO initial frame exchange may further confirm to the AP 102-b that the STA 104-c has switched to the one or more secondary subchannels. In some other implementations, the AP 102-b and the STA 104-c may communicate via the one or more secondary subchannels (for example, proceed with DSO frame exchanges) without confirming that the STA 104-c switched to the one or more secondary subchannels. The AP 102-b, the STA 104-c, or both may reduce a signaling and processing overhead associated with the DSO initial frame exchange if the wireless communication devices refraining from communicating signaling to confirm the switch.

The AP 102-b may use a control frame for the DSO initial frame exchange at 702. The control frame may indicate the one or more frequency resources for the STA 104-c to switch to for DSO (for example, for a DSO session). The control frame may trigger the STA 104-c to switch to the indicated frequency resources. In some implementations, the control frame may include padding to provide additional processing time for the STA 104-c to perform the switch to the indicated frequency resources. The control frame may or may not solicit a response (for example, an immediate or otherwise relatively low latency response) from the STA 104-c confirming the switch to the one or more frequency resources. For example, at 704, the AP 102-b may transmit an announcement frame, which may be referred to as a DSO announcement frame. The DSO announcement frame may indicate the frequency resources corresponding to one or more secondary subchannels for the STA 104-c to switch to. However, in some implementations, the DSO announcement frame may not request or otherwise solicit a response from the STA 104-c. The AP 102-b may refrain from soliciting a response from the STA 104-c confirming that the STA 104-c completed the switch to the one or more secondary subchannels, or the AP 102-b may use a second frame (for example, a trigger frame or other frame transmitted at 720) to solicit a response from the STA 104-c confirming that the switch is complete.

In some other implementations, at 706, the AP 102-b may transmit a DSO ICF. The DSO ICF may both indicate the frequency resources corresponding to the one or more secondary subchannels for the DSO session for the STA 104-c and solicit a response from the STA 104-c to confirm the completed switch. The DSO ICF, the DSO announcement frame, or both may be examples of trigger frames, where a trigger frame may include an RU allocation subfield in a user information field corresponding to the STA 104-c and indicating the one or more frequency resources for DSO.

In some implementations, the AP 102-b may support DSO announcement frames, DSO ICFs, or some combination of these or other control frames for the DSO initial frame exchange procedure. For example, the AP 102-b may support an NDP announcement frame, a BAR frame, an eMBA frame, or some combination of these or other frames to indicate the frequency resources for the STA 104-c to perform DSO.

In some implementations, at 708, the AP 102-b may transmit an NDP announcement frame. The NDP announcement frame may support sounding operations, ranging operations, or both. In some implementations, an NDP announcement frame for sounding may provide single-user or multi-user sounding. The AP 102-b may use the NDP announcement frame for multi-user sounding as a DSO announcement frame. The NDP announcement frame may include a frame control field, a duration field, a receiver address (RA) field, a transmitter address (TA) field, a sounding dialog token field, a STA information list field, an FCS field, or any combination of these or other fields. In some implementations, the sounding dialog token field may indicate whether the NDP announcement frame is a DSO announcement frame. For example, if the sounding dialog token field indicates a first value, the STA 104-c receiving the NDP announcement frame may determine that the NDP announcement frame indicates resources for DSO. Additionally, or alternatively, the STA information list field may include STA information for one or more STAs, including an AID subfield (for example, indicating the ID of a specific STA, such as the STA 104-c) and a partial bandwidth information subfield (for example, in EHT and HE variants of the NDP announcement frame format) that may indicate one or more frequency resources for the specific STA. The partial bandwidth information subfield for the STA 104-c may indicate the bandwidth in which the STA 104-c and the AP 102-b may perform sounding operations. Additionally, or alternatively, the partial bandwidth information subfield for the STA 104-c may indicate the secondary subchannel (or frequency resources within one or more secondary subchannels) to which the STA 104-c is to switch for a DSO session.

By using the NDP announcement frame as the DSO announcement frame, the AP 102-b may perform the DSO initial frame exchange and sounding operations using a same set of signals (for example, repurposing the frames for the DSO initial frame exchange to support sounding operations). Accordingly, the AP 102-b may reduce a channel overhead associated with DSO initialization and sounding (for example, by compressing the overhead associated with two different operations into one set of signals). For example, subsequent frames based on the NDP announcement frame may serve multiple purposes, such as providing sounding information and confirming that the STA 104-c (for example, a DSO STA) has switched to the indicated frequency resources for DSO. In some implementations, at 710, the AP 102-b may transmit a sounding NDP, a beamforming report poll (BFRP), or both. Additionally, or alternatively, at 712, the STA 104-c may transmit compressed beamforming feedback. The sounding NDP, the BFRP, the compressed beamforming feedback, or any combination thereof may support sounding, confirm the STA 104-c completed the switch to the indicated frequency resources for DSO, or both. For example, the AP 102-b and the STA 104-c may communicate the sounding NDP, the BFRP, the compressed beamforming feedback, or any combination thereof via one or more secondary subchannels based on the STA 104-c switching to the indicated frequency resources for DSO. In some implementations, to reduce the signaling or processing overhead (for example, if the AP 102-b can refrain from soliciting sounding information, refrain from confirming the STA 104-c completed the switching, or both), the AP 102-b, the STA 104-c, or both may refrain from communicating additional frames associated with the NDP announcement frame. For example, the AP 102-b, the STA 104-c, or both may refrain from communicating the sounding NDP, the BFRP, the compressed beamforming feedback, or any combination thereof.

In some implementations, the AP 102-b may include padding in the NDP announcement frame to provide the STA 104-c additional time to perform the switch to a different subchannel (for example, one or more secondary subchannels for DSO). For example, the NDP announcement frame may include MAC padding. The AP 102-b may include the MAC padding as one or more additional STA information fields in the NDP announcement frame, where an additional STA information field may include a value in the AID subfield (for example, 2046 or some other value) indicating that the additional STA information field represents padded (for example, null) content. In some implementations, such padding may be located before an FCS field of the NDP announcement frame. To support the STA 104-c receiving the NDP announcement frame and performing an FCS check prior to receiving or processing the padding, the AP 102-b may include an earlier FCS (for example, prior to one or more additional STA information fields including padded content). The AP 102-b may include the early FCS as a STA information field with an AID subfield set to a value (for example, 2044) indicating that the STA information field includes the FCS (for example, in the partial bandwidth information subfield or in a combination of one or more subfields). The STA 104-c may use the early FCS to perform the FCS check (for example, rather than waiting to receive the FCS at the end of the NDP announcement frame) and may perform the switch to the indicated one or more secondary subchannels for DSO at least partially during reception of the padded STA information fields.

In some implementations, at 714, the AP 102-b may transmit an eMBA frame operating as the DSO announcement frame. The eMBA frame format may be versatile and may support carrying different kinds of information. For example, the eMBA frame format may support including acknowledgment status information for the same or different STAs for the same or different TIDs. In some aspects, information in an eMBA frame may be organized as repeating per-AID TID information fields (for example, within block acknowledgment information). The AP 102-b may extend the eMBA frame to include DSO-related information. For example, the eMBA frame may include an AID field value, a TID field value, an acknowledgment type field value, or a combination of these values indicating that the eMBA frame is a DSO announcement frame. For example, if the AID field, TID field, acknowledgment type field, or combination thereof indicates that the eMBA frame includes DSO information, one or more subsequent fields of the eMBA frame may include RU or subchannel assignment information indicating one or more frequency resources for DSO for the STA 104-c. For example, a block acknowledgment starting sequence control field, a block acknowledgment bitmap field, or both may include contents indicating the one or more frequency resources for DSO. Additionally, or alternatively, the eMBA frame may include padding to allow the STA 104-c additional time to perform the switch to the indicated frequency resources for DSO. For example, the AID field, TID field, acknowledgment type field, or combination thereof may indicate that the subsequent fields (for example, the block acknowledgment starting sequence control field, the block acknowledgment bitmap field, or both) include padded (for example, null) content or an early FCS, similar to the NDP announcement frame described herein.

In some implementations, at 716, the AP 102-b may transmit a BAR frame operating as the DSO announcement frame. The AP 102-b may set a BAR type subfield of the BAR frame to a value indicating that the BAR frame includes DSO-related information. For example, if the BAR type subfield is set to the value indicating that the BAR frame includes DSO-related information, a BAR information field of the BAR frame may include RU or subchannel assignment information indicating one or more frequency resources for DSO for the STA 104-c. Additionally, or alternatively, the BAR type subfield may indicate whether padding, an early FCS, or both are included in the BAR frame.

At 718, the STA 104-c may switch to the one or more frequency resources indicated for DSO. For example, to begin a DSO session, the STA 104-c may switch from communicating via a primary subchannel to communicating via one or more secondary subchannels including the one or more frequency resources indicated by the received frame operating as the DSO announcement frame (for example, any control frame indicating the frequency resources for DSO, as described herein). In some implementations, the STA 104-c may switch to the one or more secondary subchannels for DSO communications based on padded content in the frame operating as the DSO announcement frame.

In some implementations, at 720, the AP 102-b may transmit a trigger frame to trigger a response from the STA 104-c. At 722, the STA 104-c may transmit a response frame in response to the trigger frame. The wireless communication devices may communicate the trigger frame, the response frame, or both via the one or more secondary subchannels for DSO to indicate that the STA 104-c is communicating via the one or more secondary subchannels and, correspondingly, has successfully switched to the one or more secondary subchannels for DSO. The response frame may operate as a confirmation to the AP 102-b that the STA 104-c switched to the one or more secondary subchannels for DSO. In some implementations, this confirmation may complete the DSO initial frame exchange activating the DSO session at the STA 104-c.

At 724, the STA 104-c and the AP 102-b may communicate one or more PPDUs via the one or more secondary subchannels for DSO (for example, via the one or more frequency resources for the DSO session at the STA 104-c). The STA 104-c may remain communicating via the one or more secondary subchannels for DSO until identifying a trigger (for example, a time-based trigger or a frame-based trigger) to switch back to the primary subchannel. The STA 104-c may end the DSO session upon switching back to the primary subchannel. Accordingly, the DSO session may span one or more TxOPs, for example, based on a single DSO initial frame exchange activating the DSO session. The STA 104-c may reduce a signaling overhead associated with activating DSO based on maintaining communications via the one or more secondary subchannels for DSO after the end of a first TxOP.

In some implementations, at 726, the AP 102-b may transmit a frame that triggers the STA 104-c to switch back to the primary subchannel for communications. For example, the frame may be an example of a frame-based trigger deactivating the DSO session at the STA 104-c. Additionally, or alternatively, at 728, the STA 104-c may determine a time-based trigger. For example, the AP 102-b may configure the STA 104-c with a time-based trigger (for example, a duration, a TSF value, an epoch, or some combination thereof as described herein with reference to FIG. 5) for deactivating the DSO session.

At 730, the STA 104-c may deactivate the DSO session and switch back to the primary subchannel for communications based on the frame-based trigger, the time-based trigger, or both. At 732, the STA 104-c and the AP 102-b may communicate one or more additional PPDUs via the primary subchannel.

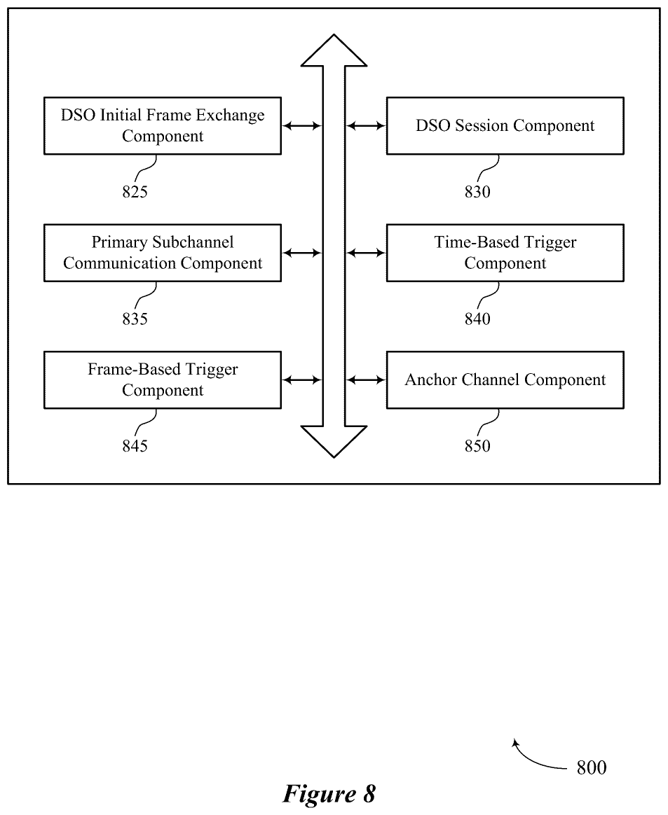

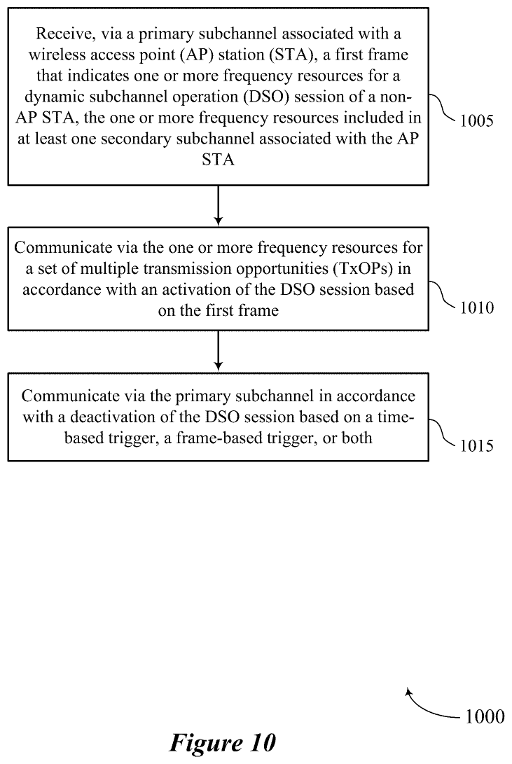

FIG. 8 shows a block diagram of an example wireless communication device 800 that supports semi-static switching for DSO. In some implementations, the wireless communication device 800 is configured to perform the process 1000 described with reference to FIG. 10. The wireless communication device 800 may be an example of a non-AP STA, such as a STA 104. The wireless communication device 800 may include one or more chips, systems-on-chips (SoCs), chipsets, packages, components, or devices that individually or collectively constitute or include a processing system. The processing system may interface with other components of the wireless communication device 800 and may generally process information (such as inputs or signals) received from such other components and output information (such as outputs or signals) to such other components. In some aspects, an example chip may include a processing system, a first interface to output or transmit information, and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), or digital signal processors (DSPs)), processing blocks, application-specific integrated circuits (ASICs), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements, or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers.

In some implementations, the wireless communication device 800 can be configurable or configured for use in a non-AP STA, such as the STA 104 described with reference to FIG. 1. In some other implementations, the wireless communication device 800 can be a STA that includes such a processing system and other components including multiple antennas. The wireless communication device 800 may be capable of transmitting and receiving wireless communications in the form of, for example, wireless packets. For example, the wireless communication device 800 can be configurable or configured to transmit and receive packets in the form of PPDUs and MPDUs conforming to one or more of the IEEE 802.11 family of wireless communication protocol standards. In some other implementations, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system.

The wireless communication device 800 includes a DSO initial frame exchange component 825, a DSO session component 830, a primary subchannel communication component 835, a time-based trigger component 840, a frame-based trigger component 845, and an anchor channel component 850. Portions of one or more of the DSO initial frame exchange component 825, the DSO session component 830, the primary subchannel communication component 835, the time-based trigger component 840, the frame-based trigger component 845, and the anchor channel component 850 may be implemented at least in part in hardware or firmware. For example, one or more of the DSO initial frame exchange component 825, the DSO session component 830, the primary subchannel communication component 835, the time-based trigger component 840, the frame-based trigger component 845, and the anchor channel component 850 may be implemented at least in part by at least a processor or a modem. In some implementations, portions of one or more of the DSO initial frame exchange component 825, the DSO session component 830, the primary subchannel communication component 835, the time-based trigger component 840, the frame-based trigger component 845, and the anchor channel component 850 may be implemented at least in part by a processor and software in the form of processor-executable code stored in memory.

The wireless communication device 800 may support wireless communications at a non-AP STA in accordance with examples as disclosed herein. The DSO initial frame exchange component 825 is configurable or configured to receive, via a primary subchannel associated with an AP STA, a first frame that indicates one or more frequency resources for a DSO session of the non-AP STA, the one or more frequency resources included in at least one secondary subchannel associated with the AP STA. The DSO session component 830 is configurable or configured to communicate via the one or more frequency resources for a set of multiple TxOPs in accordance with an activation of the DSO session based on the first frame. The primary subchannel communication component 835 is configurable or configured to communicate via the primary subchannel in accordance with a deactivation of the DSO session based on a time-based trigger, a frame-based trigger, or both.

In some implementations, the time-based trigger component 840 is configurable or configured to receive an indication of a duration for operation in the DSO session. In some implementations, the time-based trigger component 840 is configurable or configured to switch to the primary subchannel for the communicating via the primary subchannel based on an expiration of the duration, where the time-based trigger includes the duration. In some implementations, the indication of the duration is received in the first frame, a management frame, a beacon frame, or a combination thereof.

In some implementations, the time-based trigger component 840 is configurable or configured to receive an indication of a TSF value for the deactivation of the DSO session. In some implementations, the time-based trigger component 840 is configurable or configured to switch to the primary subchannel for the communicating via the primary subchannel based on the TSF value, where the time-based trigger includes the TSF value. In some implementations, the indication of the TSF value is received in the first frame, a management frame, a beacon frame, or a combination thereof.

In some implementations, the time-based trigger component 840 is configurable or configured to switch to the primary subchannel for the communicating via the primary subchannel based on a first TBTT associated with the AP STA, a second TBTT for a DTIM beacon associated with the AP STA, a TWT SP associated with the AP STA, or a combination thereof, where the time-based trigger includes the first TBTT, the second TBTT, the TWT SP, or a combination thereof.

In some implementations, the frame-based trigger component 845 is configurable or configured to receive, via the one or more frequency resources, a second frame that indicates for the non-AP STA to switch back to the primary subchannel. In some implementations, the frame-based trigger component 845 is configurable or configured to switch to the primary subchannel for the communicating via the primary subchannel based on the second frame, where the frame-based trigger includes the second frame. In some implementations, the second frame indicates one or more second frequency resources for the non-AP STA, the one or more second frequency resources included at least partially in the primary subchannel.

In some implementations, the frame-based trigger component 845 is configurable or configured to receive, via the one or more frequency resources, a second frame that indicates one or more second frequency resources for the DSO session of the non-AP STA, the one or more second frequency resources included in at least one second secondary subchannel associated with the AP STA, the at least one second secondary subchannel different from the at least one secondary subchannel. In some implementations, the frame-based trigger component 845 is configurable or configured to switch to the one or more second frequency resources based on the second frame and the DSO session at the non-AP STA.

In some implementations, the time-based trigger component 840 is configurable or configured to switch to the primary subchannel for the communicating via the primary subchannel prior to the time-based trigger. In some implementations, the time-based trigger component 840 is configurable or configured to transmit, via the primary subchannel, a second frame to indicate the switching to the primary subchannel.

In some implementations, to support communicating via the one or more frequency resources for the set of multiple TxOPs, the DSO session component 830 is configurable or configured to receive one or more MU PPDUs. In some implementations, to support communicating via the one or more frequency resources for the set of multiple TxOPs, the DSO session component 830 is configurable or configured to transmit one or more TB PPDUs.

In some implementations, to support communicating via the one or more frequency resources for the set of multiple TxOPs, the DSO session component 830 is configurable or configured to receive one or more downlink frames based on the at least one O-Primary subchannel. In some implementations, to support communicating via the one or more frequency resources for the set of multiple TxOPs, the DSO session component 830 is configurable or configured to transmit one or more uplink frames based on an OBSS STA occupying the primary subchannel and a contention procedure for the at least one O-Primary subchannel.

In some implementations, to support communicating via the one or more frequency resources for the set of multiple TxOPs, the DSO session component 830 is configurable or configured to receive a group-addressed frame corresponding to a DUP PPDU format via the one or more frequency resources.

In some implementations, to support communicating via the one or more frequency resources for the set of multiple TxOPs, the anchor channel component 850 is configurable or configured to monitor a portion (for example, corresponding to an anchor channel) of the at least one secondary subchannel for one or more PPDUs.

In some implementations, the anchor channel component 850 is configurable or configured to receive an indication of static puncturing of the at least one secondary subchannel, such as the monitored portion of the at least one secondary subchannel, the anchor channel of the at least one secondary subchannel, or some other resources of the at least one secondary subchannel. In some implementations, the anchor channel component 850 is configurable or configured to switch to the primary subchannel for the communicating via the primary subchannel based on the indication of the static puncturing.

In some implementations, the anchor channel includes a first anchor channel, and the anchor channel component 850 is configurable or configured to receive an indication to switch from the first anchor channel to a second anchor channel of the at least one secondary subchannel. In some such implementations, the anchor channel component 850 is configurable or configured to monitor the second anchor channel for one or more additional PPDUs based on the indication to switch.

In some implementations, the first frame includes an announcement frame, and the DSO initial frame exchange component 825 is configurable or configured to receive a second frame that triggers a switch to the one or more frequency resources, where the communicating via the one or more frequency resources is based on the second frame.

In some implementations, the first frame includes a trigger frame that triggers a switch to the one or more frequency resources, where the communicating via the one or more frequency resources is based on the trigger frame.

In some implementations, the DSO initial frame exchange component 825 is configurable or configured to transmit a response frame confirming a switch to the one or more frequency resources for the DSO session.

In some implementations, the communicating via the one or more frequency resources confirms a switch to the one or more frequency resources for the DSO session.

In some implementations, the first frame includes an NDP announcement frame. In some implementations, the DSO initial frame exchange component 825 is configurable or configured to transmit a sounding NDP frame, a BFRP frame, a compressed beamforming feedback frame, or a combination thereof based on the NDP announcement frame, where the sounding NDP frame, the BFRP frame, the compressed beamforming feedback frame, or a combination thereof confirms a switch to the one or more frequency resources for the DSO session. In some implementations, the NDP announcement frame includes a partial bandwidth information field of a STA information field corresponding to the non-AP STA, the partial bandwidth information field indicating the one or more frequency resources for the DSO session of the non-AP STA. In some implementations, the NDP announcement frame includes MAC padding, a STA information field including a first value corresponding to padded content, an initial frame check sequence prior to padding, or a combination thereof.

In some implementations, the first frame includes an eMBA frame. In some implementations, the eMBA frame includes an AID field, an acknowledgment type field, a TID field, or a combination thereof indicating that the eMBA frame is associated with the DSO session. In some implementations, the eMBA frame includes a BA starting sequence control field, a BA bitmap field, or both indicating the one or more frequency resources for the DSO session of the non-AP STA.

In some implementations, the first frame includes a BAR frame. In some implementations, the BAR frame includes a BAR type field indicating that the BAR frame is associated with the DSO session. In some implementations, the BAR frame includes a BAR information field indicating the one or more frequency resources for the DSO session of the non-AP STA.

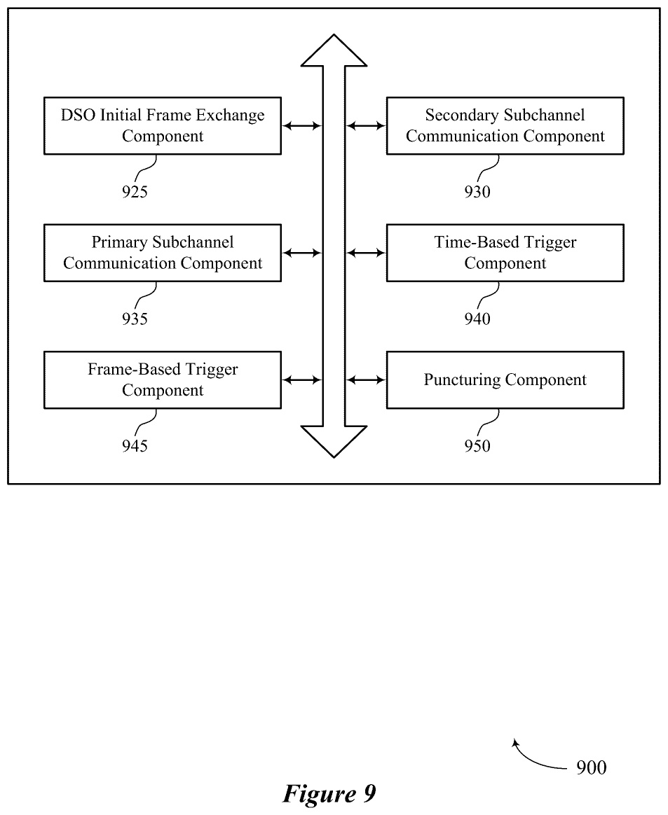

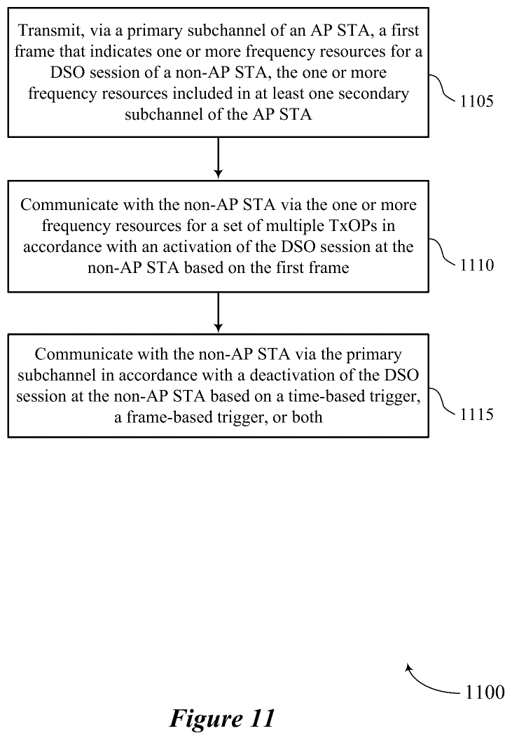

FIG. 9 shows a block diagram of an example wireless communication device 900 that supports semi-static switching for DSO. In some implementations, the wireless communication device 900 is configured to perform the process 1100 described with reference to FIG. 11. The wireless communication device 900 may be an example of an AP STA, such as an AP 102 as described herein. The wireless communication device 900 may include one or more chips, SoCs, chipsets, packages, components, or devices that individually or collectively constitute or include a processing system. The processing system may interface with other components of the wireless communication device 900 and may generally process information (such as inputs or signals) received from such other components and output information (such as outputs or signals) to such other components. In some aspects, an example chip may include a processing system, a first interface to output or transmit information, and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as CPUs, GPUs, or DSPs), processing blocks, ASICs, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements, or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers.

In some implementations, the wireless communication device 900 can be configurable or configured for use in an AP, such as the AP 102 described with reference to FIG. 1. In some other implementations, the wireless communication device 900 can be an AP that includes such a processing system and other components including multiple antennas. The wireless communication device 900 may be capable of transmitting and receiving wireless communications in the form of, for example, wireless packets. For example, the wireless communication device 900 can be configurable or configured to transmit and receive packets in the form of PPDUs and MPDUs conforming to one or more of the IEEE 802.11 family of wireless communication protocol standards. In some other implementations, the wireless communication device 900 can be configurable or configured to transmit and receive signals and communications conforming to one or more 3GPP specifications including those for 5G NR or 6G. In some implementations, the wireless communication device 900 also includes or can be coupled with one or more application processors which may be further coupled with one or more other memories. In some implementations, the wireless communication device 900 further includes at least one external network interface coupled with the processing system that enables communication with a core network or backhaul network that enables the wireless communication device 900 to gain access to external networks including the Internet.

The wireless communication device 900 includes a DSO initial frame exchange component 925, a secondary subchannel communication component 930, a primary subchannel communication component 935, a time-based trigger component 940, a frame-based trigger component 945, and a puncturing component 950. Portions of one or more of the DSO initial frame exchange component 925, the secondary subchannel communication component 930, the primary subchannel communication component 935, the time-based trigger component 940, the frame-based trigger component 945, and the puncturing component 950 may be implemented at least in part in hardware or firmware. For example, one or more of the DSO initial frame exchange component 925, the secondary subchannel communication component 930, the primary subchannel communication component 935, the time-based trigger component 940, the frame-based trigger component 945, and the puncturing component 950 may be implemented at least in part by at least a processor or a modem. In some implementations, portions of one or more of the DSO initial frame exchange component 925, the secondary subchannel communication component 930, the primary subchannel communication component 935, the time-based trigger component 940, the frame-based trigger component 945, and the puncturing component 950 may be implemented at least in part by a processor and software in the form of processor-executable code stored in memory.

The wireless communication device 900 may support wireless communications at an AP STA in accordance with examples as disclosed herein. The DSO initial frame exchange component 925 is configurable or configured to transmit, via a primary subchannel of the AP STA, a first frame that indicates one or more frequency resources for a DSO session of a non-AP STA, the one or more frequency resources included in at least one secondary subchannel of the AP STA. The secondary subchannel communication component 930 is configurable or configured to communicate with the non-AP STA via the one or more frequency resources for a set of multiple TxOPs in accordance with an activation of the DSO session at the non-AP STA based on the first frame. The primary subchannel communication component 935 is configurable or configured to communicate with the non-AP STA via the primary subchannel in accordance with a deactivation of the DSO session at the non-AP STA based on a time-based trigger, a frame-based trigger, or both.

In some implementations, the time-based trigger component 940 is configurable or configured to transmit an indication of a duration for operation in the DSO session, where the time-based trigger includes the duration. In some implementations, to support transmitting the indication of the duration, the time-based trigger component 940 is configurable or configured to transmit a management frame indicating the duration for the operation in the DSO session to a set of multiple non-AP STAs including at least the non-AP STA. In some implementations, the first frame includes the indication of the duration.

In some implementations, the time-based trigger component 940 is configurable or configured to transmit an indication of a TSF value for the deactivation of the DSO session at the non-AP STA, where the time-based trigger includes the TSF value. In some implementations, the indication of the TSF value is transmitted in the first frame, a management frame, or a combination thereof.

In some implementations, the time-based trigger includes a first TBTT associated with the AP STA, a second TBTT for a DTIM beacon associated with the AP STA, a TWT SP associated with the AP STA, or a combination thereof.

In some implementations, the frame-based trigger component 945 is configurable or configured to transmit, via the one or more frequency resources, a second frame that indicates for the non-AP STA to switch back to the primary subchannel, where the frame-based trigger includes the second frame. In some implementations, the second frame indicates one or more second frequency resources for the non-AP STA, the one or more second frequency resources included at least partially in the primary subchannel.

In some implementations, the frame-based trigger component 945 is configurable or configured to transmit, via the one or more frequency resources, a second frame that indicates one or more second frequency resources for the DSO session of the non-AP STA, the one or more second frequency resources included in at least one second secondary subchannel of the AP STA, the at least one second secondary subchannel different from the at least one secondary subchannel. In some implementations, the frame-based trigger component 945 is configurable or configured to communicate with the non-AP STA via the one or more second frequency resources for a second set of multiple TxOPs based on the second frame and the DSO session at the non-AP STA.

In some implementations, the primary subchannel communication component 935 is configurable or configured to receive, via the primary subchannel, a second frame indicating that the non-AP STA switched to the primary subchannel, where the communicating with the non-AP STA via the primary subchannel is based on the second frame.

In some implementations, to support communicating with the non-AP STA via the one or more frequency resources for the set of multiple TxOPs, the secondary subchannel communication component 930 is configurable or configured to schedule one or more resources within the at least one secondary subchannel for communication with the non-AP STA while the DSO session at the non-AP STA is active.

In some implementations, to support communicating with the non-AP STA via the one or more frequency resources for the set of multiple TxOPs, the secondary subchannel communication component 930 is configurable or configured to transmit one or more MU PPDUs. In some implementations, to support communicating with the non-AP STA via the one or more frequency resources for the set of multiple TxOPs, the secondary subchannel communication component 930 is configurable or configured to receive one or more TB PPDUs.

In some implementations, to support communicating via the one or more frequency resources for the set of multiple TxOPs, the secondary subchannel communication component 930 is configurable or configured to detect an OBSS STA occupying the primary subchannel. In some implementations, to support communicating via the one or more frequency resources for the set of multiple TxOPs, the secondary subchannel communication component 930 is configurable or configured to communicate one or more frames via the at least one O-Primary subchannel based on the detected OBSS STA.

In some implementations, to support communicating with the non-AP STA via the one or more frequency resources for the set of multiple TxOPs, the secondary subchannel communication component 930 is configurable or configured to transmit a group-addressed frame corresponding to a DUP PPDU format via the one or more frequency resources.

In some implementations, the puncturing component 950 is configurable or configured to refrain from dynamically puncturing an anchor channel of the at least one secondary subchannel for the non-AP STA.

In some implementations, the puncturing component 950 is configurable or configured to transmit an indication of static puncturing of a portion (for example, corresponding to an anchor channel) of the at least one secondary subchannel for the non-AP STA, where the communicating with the non-AP STA via the primary subchannel is based on the static puncturing.

In some implementations, the secondary subchannel communication component 930 is configurable or configured to transmit an indication for the non-AP STA to switch from a first anchor channel of the at least one secondary subchannel for the non-AP STA to a second anchor channel of the at least one secondary subchannel for the non-AP STA, where the communicating with the non-AP STA via the one or more frequency resources is based on the second anchor channel.

In some implementations, the first frame includes an announcement frame, and the DSO initial frame exchange component 925 is configurable or configured to transmit a second frame for the non-AP STA to switch to the one or more frequency resources, where the communicating with the non-AP STA via the one or more frequency resources is based on the second frame.

In some implementations, the first frame includes an announcement frame, and the DSO initial frame exchange component 925 is configurable or configured to determine to transmit a trigger frame for the non-AP STA based on an OBSS STA. In some implementations, the first frame includes an announcement frame, and the DSO initial frame exchange component 925 is configurable or configured to transmit the trigger frame for the non-AP STA to switch to the one or more frequency resources based on the determining. In some implementations, the first frame includes an announcement frame, and the DSO initial frame exchange component 925 is configurable or configured to receive a response frame confirming the non-AP STA switched to the one or more frequency resources for the DSO session based on the trigger frame.

In some implementations, the first frame includes a trigger frame for the non-AP STA to switch to the one or more frequency resources, where the communicating with the non-AP STA via the one or more frequency resources is based on the trigger frame.

In some implementations, the communicating with the non-AP STA via the one or more frequency resources confirms the non-AP STA switched to the one or more frequency resources for the DSO session.

In some implementations, the first frame includes an NDP announcement frame. In some implementations, the DSO initial frame exchange component 925 is configurable or configured to receive a sounding NDP frame, a BFRP frame, a compressed beamforming feedback frame, or a combination thereof based on the NDP announcement frame, where the sounding NDP frame, the BFRP frame, the compressed beamforming feedback frame, or a combination thereof confirms the non-AP STA switched to the one or more frequency resources for the DSO session. In some implementations, the NDP announcement frame includes a partial bandwidth information field of a STA information field corresponding to the non-AP STA, the partial bandwidth information field indicating the one or more frequency resources for the DSO session of the non-AP STA. In some implementations, the NDP announcement frame includes MAC padding, a STA information field including a first value corresponding to padded content, an initial frame check sequence prior to padding, or a combination thereof.

In some implementations, the first frame includes an eMBA frame. In some implementations, the eMBA frame includes an AID field, an acknowledgment type field, a TID field, or a combination thereof indicating that the eMBA frame is associated with the DSO session. In some implementations, the eMBA frame includes a BA starting sequence control field, a BA bitmap field, or both indicating the one or more frequency resources for the DSO session of the non-AP STA.

In some implementations, the first frame includes a BAR frame. In some implementations, the BAR frame includes a BAR type field indicating that the BAR frame is associated with the DSO session. In some implementations, the BAR frame includes a BAR information field indicating the one or more frequency resources for the DSO session of the non-AP STA.

FIG. 10 shows a flowchart illustrating an example process 1000 performable by or at a non-AP STA that supports semi-static switching for DSO. The operations of the process 1000 may be implemented by a non-AP STA, such as a STA 104, or its components as described herein. For example, the process 1000 may be performed by a wireless communication device, such as the wireless communication device 800 described with reference to FIG. 8, operating as or within a wireless STA. In some implementations, the process 1000 may be performed by a wireless STA, such as one of the STAs 104 described with reference to FIG. 1.

In some implementations, in block 1005, the non-AP STA may receive, via a primary subchannel associated with an AP STA, a first frame that indicates one or more frequency resources for a DSO session of the non-AP STA, the one or more frequency resources included in at least one secondary subchannel associated with the AP STA. The operations of block 1005 may be performed in accordance with examples as disclosed herein. In some implementations, aspects of the operations of block 1005 may be performed by a DSO initial frame exchange component 825 as described with reference to FIG. 8.

In some implementations, in block 1010, the non-AP STA may communicate via the one or more frequency resources for a set of multiple TxOPs in accordance with an activation of the DSO session based on the first frame. The operations of block 1010 may be performed in accordance with examples as disclosed herein. In some implementations, aspects of the operations of block 1010 may be performed by a DSO session component 830 as described with reference to FIG. 8.

In some implementations, in block 1015, the non-AP STA may communicate via the primary subchannel in accordance with a deactivation of the DSO session based on a time-based trigger, a frame-based trigger, or both. The operations of block 1015 may be performed in accordance with examples as disclosed herein. In some implementations, aspects of the operations of block 1015 may be performed by a primary subchannel communication component 835 as described with reference to FIG. 8.

FIG. 11 shows a flowchart illustrating an example process 1100 performable by or at an AP STA that supports semi-static switching for DSO. The operations of the process 1100 may be implemented by an AP STA, such as an AP 102, or its components as described herein. For example, the process 1100 may be performed by a wireless communication device, such as the wireless communication device 900 described with reference to FIG. 9, operating as or within a wireless AP. In some implementations, the process 1100 may be performed by a wireless AP, such as one of the APs 102 described with reference to FIG. 1.

In some implementations, in block 1105, the AP STA may transmit, via a primary subchannel of the AP STA, a first frame that indicates one or more frequency resources for a DSO session of a non-AP STA, the one or more frequency resources included in at least one secondary subchannel of the AP STA. The operations of block 1105 may be performed in accordance with examples as disclosed herein. In some implementations, aspects of the operations of block 1105 may be performed by a DSO initial frame exchange component 925 as described with reference to FIG. 9.

In some implementations, in block 1110, the AP STA may communicate with the non-AP STA via the one or more frequency resources for a set of multiple TxOPs in accordance with an activation of the DSO session at the non-AP STA based on the first frame. The operations of block 1110 may be performed in accordance with examples as disclosed herein. In some implementations, aspects of the operations of block 1110 may be performed by a secondary subchannel communication component 930 as described with reference to FIG. 9.

In some implementations, in block 1115, the AP STA may communicate with the non-AP STA via the primary subchannel in accordance with a deactivation of the DSO session at the non-AP STA based on a time-based trigger, a frame-based trigger, or both. The operations of block 1115 may be performed in accordance with examples as disclosed herein. In some implementations, aspects of the operations of block 1115 may be performed by a primary subchannel communication component 935 as described with reference to FIG. 9.

Implementation examples are described in the following numbered clauses:

Aspect 1: A method for wireless communications at a non-AP STA, comprising: receiving, via a primary subchannel associated with an AP STA, a first frame that indicates one or more frequency resources for a DSO session of the non-AP STA, the one or more frequency resources included in at least one secondary subchannel associated with the AP STA; communicating via the one or more frequency resources for a plurality of TxOPs in accordance with an activation of the DSO session based at least in part on the first frame; and communicating via the primary subchannel in accordance with a deactivation of the DSO session based at least in part on a time-based trigger, a frame-based trigger, or both.

Aspect 2: The method of aspect 1, further comprising: receiving an indication of a duration for operation in the DSO session; and switching to the primary subchannel for the communicating via the primary subchannel based at least in part on an expiration of the duration, wherein the time-based trigger comprises the duration.

Aspect 3: The method of aspect 2, wherein the indication of the duration is received in the first frame, a management frame, a beacon frame, or a combination thereof.

Aspect 4: The method of any of aspects 1-3, further comprising: receiving an indication of a TSF value for the deactivation of the DSO session; and switching to the primary subchannel for the communicating via the primary subchannel based at least in part on the TSF value, wherein the time-based trigger comprises the TSF value.

Aspect 5: The method of aspect 4, wherein the indication of the TSF value is received in the first frame, a management frame, a beacon frame, or a combination thereof.

Aspect 6: The method of any of aspects 1-5, further comprising: switching to the primary subchannel for the communicating via the primary subchannel based at least in part on a first TBTT associated with the AP STA, a second TBTT for a DTIM beacon associated with the AP STA, a TWT SP associated with the AP STA, or a combination thereof, wherein the time-based trigger comprises the first TBTT, the second TBTT, the TWT SP, or a combination thereof.

Aspect 7: The method of any of aspects 1-6, further comprising: receiving, via the one or more frequency resources, a second frame that indicates for the non-AP STA to switch back to the primary subchannel; and switching to the primary subchannel for the communicating via the primary subchannel based at least in part on the second frame, wherein the frame-based trigger comprises the second frame.

Aspect 8: The method of aspect 7, wherein the second frame indicates one or more second frequency resources for the non-AP STA, the one or more second frequency resources included at least partially in the primary subchannel.

Aspect 9: The method of any of aspects 1-8, further comprising: receiving, via the one or more frequency resources, a second frame that indicates one or more second frequency resources for the DSO session of the non-AP STA, the one or more second frequency resources included in at least one second secondary subchannel associated with the AP STA, the at least one second secondary subchannel different from the at least one secondary subchannel; and switching to the one or more second frequency resources based at least in part on the second frame and the DSO session at the non-AP STA.

Aspect 10: The method of any of aspects 1-9, further comprising: switching to the primary subchannel for the communicating via the primary subchannel prior to the time-based trigger; and transmitting, via the primary subchannel, a second frame to indicate the switching to the primary subchannel.

Aspect 11: The method of any of aspects 1-10, wherein communicating via the one or more frequency resources for the plurality of TxOPs comprises: receiving one or more MU PPDUs; transmitting one or more TB PPDUs; or both.

Aspect 12: The method of any of aspects 1-11, wherein the at least one secondary subchannel comprises at least one O-Primary subchannel, and wherein communicating via the one or more frequency resources for the plurality of TxOPs comprises: receiving one or more downlink frames based at least in part on the at least one O-Primary subchannel; transmitting one or more uplink frames based at least in part on an OBSS STA occupying the primary subchannel and a contention procedure for the at least one O-Primary subchannel; or both.

Aspect 13: The method of any of aspects 1-12, wherein communicating via the one or more frequency resources for the plurality of TxOPs comprises: receiving a group-addressed frame corresponding to a DUP PPDU format via the one or more frequency resources.

Aspect 14: The method of any of aspects 1-13, wherein communicating via the one or more frequency resources for the plurality of TxOPs comprises: monitoring a portion of the at least one secondary subchannel for one or more PPDUs.

Aspect 15: The method of aspect 14, further comprising: receiving an indication of static puncturing of the at least one secondary subchannel; and switching to the primary subchannel for the communicating via the primary subchannel based at least in part on the indication of the static puncturing.

Aspect 16: The method of any of aspects 14-15, wherein the portion comprises a first anchor channel, the method further comprising: receiving an indication to switch from the first anchor channel to a second anchor channel of the at least one secondary subchannel; and monitoring the second anchor channel for one or more additional PPDUs based at least in part on the indication to switch.

Aspect 17: The method of any of aspects 1-16, wherein the first frame comprises an announcement frame, the method further comprising: receiving a second frame that triggers a switch to the one or more frequency resources, wherein the communicating via the one or more frequency resources is based at least in part on the second frame.

Aspect 18: The method of any of aspects 1-17, wherein the first frame comprises a trigger frame that triggers a switch to the one or more frequency resources, wherein the communicating via the one or more frequency resources is based at least in part on the trigger frame.

Aspect 19: The method of any of aspects 1-18, further comprising: transmitting a response frame confirming a switch to the one or more frequency resources for the DSO session.

Aspect 20: The method of any of aspects 1-19, wherein the communicating via the one or more frequency resources confirms a switch to the one or more frequency resources for the DSO session.

Aspect 21: The method of any of aspects 1-20, wherein the first frame comprises an NDP announcement frame.

Aspect 22: The method of aspect 21, further comprising: transmitting a sounding NDP frame, a BFRP frame, a compressed beamforming feedback frame, or a combination thereof based at least in part on the NDP announcement frame, wherein the sounding NDP frame, the BFRP frame, the compressed beamforming feedback frame, or a combination thereof confirms a switch to the one or more frequency resources for the DSO session.

Aspect 23: The method of any of aspects 21-22, wherein the NDP announcement frame comprises a partial bandwidth information field of a STA information field corresponding to the non-AP STA, the partial bandwidth information field indicating the one or more frequency resources for the DSO session of the non-AP STA.

Aspect 24: The method of any of aspects 21-23, wherein the NDP announcement frame comprises MAC padding, a STA information field comprising a first value corresponding to padded content, an initial FCS prior to padding, or a combination thereof.

Aspect 25: The method of any of aspects 1-24, wherein the first frame comprises an eMBA frame.

Aspect 26: The method of aspect 25, wherein the eMBA frame comprises an AID field, an acknowledgment type field, a TID field, or a combination thereof indicating that the eMBA frame is associated with the DSO session; and the eMBA frame comprises a block acknowledgment starting sequence control field, a block acknowledgment bitmap field, or both indicating the one or more frequency resources for the DSO session of the non-AP STA.

Aspect 27: The method of any of aspects 1-26, wherein the first frame comprises a BAR frame.

Aspect 28: The method of aspect 27, wherein the BAR frame comprises a BAR type field indicating that the BAR frame is associated with the DSO session; and the BAR frame comprises a BAR information field indicating the one or more frequency resources for the DSO session of the non-AP STA.

Aspect 29: A method for wireless communications at an AP STA, comprising: transmitting, via a primary subchannel of the AP STA, a first frame that indicates one or more frequency resources for a DSO session of a non-AP STA, the one or more frequency resources included in at least one secondary subchannel of the AP STA; communicating with the non-AP STA via the one or more frequency resources for a plurality of TxOPs in accordance with an activation of the DSO session at the non-AP STA based at least in part on the first frame; and communicating with the non-AP STA via the primary subchannel in accordance with a deactivation of the DSO session at the non-AP STA based at least in part on a time-based trigger, a frame-based trigger, or both.

Aspect 30: The method of aspect 29, further comprising: transmitting an indication of a duration for operation in the DSO session, wherein the time-based trigger comprises the duration.

Aspect 31: The method of aspect 30, wherein transmitting the indication of the duration comprises: transmitting a management frame indicating the duration for the operation in the DSO session to a plurality of non-AP STAs comprising at least the non-AP STA.

Aspect 32: The method of any of aspects 30-31, wherein the first frame comprises the indication of the duration.

Aspect 33: The method of any of aspects 29-32, further comprising: transmitting an indication of a TSF value for the deactivation of the DSO session at the non-AP STA, wherein the time-based trigger comprises the TSF value.

Aspect 34: The method of aspect 33, wherein the indication of the TSF value is transmitted in the first frame, a management frame, or a combination thereof.

Aspect 35: The method of any of aspects 29-34, wherein the time-based trigger comprises a first TBTT associated with the AP STA, a second TBTT for a DTIM beacon associated with the AP STA, a TWT SP associated with the AP STA, or a combination thereof.

Aspect 36: The method of any of aspects 29-35, further comprising: transmitting, via the one or more frequency resources, a second frame that indicates for the non-AP STA to switch back to the primary subchannel, wherein the frame-based trigger comprises the second frame.

Aspect 37: The method of aspect 36, wherein the second frame indicates one or more second frequency resources for the non-AP STA, the one or more second frequency resources included at least partially in the primary subchannel.

Aspect 38: The method of any of aspects 29-37, further comprising: transmitting, via the one or more frequency resources, a second frame that indicates one or more second frequency resources for the DSO session of the non-AP STA, the one or more second frequency resources included in at least one second secondary subchannel of the AP STA, the at least one second secondary subchannel different from the at least one secondary subchannel; and communicating with the non-AP STA via the one or more second frequency resources for a second plurality of TxOPs based at least in part on the second frame and the DSO session at the non-AP STA.

Aspect 39: The method of any of aspects 29-38, further comprising: receiving, via the primary subchannel, a second frame indicating that the non-AP STA switched to the primary subchannel, wherein the communicating with the non-AP STA via the primary subchannel is based at least in part on the second frame.

Aspect 40: The method of any of aspects 29-39, wherein communicating with the non-AP STA via the one or more frequency resources for the plurality of TxOPs comprises: scheduling one or more resources within the at least one secondary subchannel for communication with the non-AP STA while the DSO session at the non-AP STA is active.

Aspect 41: The method of any of aspects 29-40, wherein communicating with the non-AP STA via the one or more frequency resources for the plurality of TxOPs comprises: transmitting one or more MU PPDUs; receiving one or more TB PPDUs; or both.

Aspect 42: The method of any of aspects 29-41, wherein the at least one secondary subchannel comprises at least one O-Primary subchannel, and wherein communicating via the one or more frequency resources for the plurality of TxOPs comprises: detecting an OBSS STA occupying the primary subchannel; and communicating one or more frames via the at least one O-Primary subchannel based at least in part on the detected OBSS STA.

Aspect 43: The method of any of aspects 29-42, wherein communicating with the non-AP STA via the one or more frequency resources for the plurality of TxOPs comprises: transmitting a group-addressed frame corresponding to a DUP PPDU format via the one or more frequency resources.

Aspect 44: The method of any of aspects 29-43, further comprising: refraining from dynamically puncturing an anchor channel of the at least one secondary subchannel for the non-AP STA.

Aspect 45: The method of any of aspects 29-44, further comprising: transmitting an indication of static puncturing of a portion of the at least one secondary subchannel for the non-AP STA, wherein the communicating with the non-AP STA via the primary subchannel is based at least in part on the static puncturing.

Aspect 46: The method of any of aspects 29-45, further comprising: transmitting an indication for the non-AP STA to switch from a first anchor channel of the at least one secondary subchannel for the non-AP STA to a second anchor channel of the at least one secondary subchannel for the non-AP STA, wherein the communicating with the non-AP STA via the one or more frequency resources is based at least in part on the second anchor channel.

Aspect 47: The method of any of aspects 29-46, wherein the first frame comprises an announcement frame, the method further comprising: transmitting a second frame for the non-AP STA to switch to the one or more frequency resources, wherein the communicating with the non-AP STA via the one or more frequency resources is based at least in part on the second frame.

Aspect 48: The method of any of aspects 29-47, wherein the first frame comprises an announcement frame, the method further comprising: determining to transmit a trigger frame for the non-AP STA based at least in part on an OBSS STA; transmitting the trigger frame for the non-AP STA to switch to the one or more frequency resources based at least in part on the determining; and receiving a response frame confirming the non-AP STA switched to the one or more frequency resources for the DSO session based at least in part on the trigger frame.

Aspect 49: The method of any of aspects 29-48, wherein the first frame comprises a trigger frame for the non-AP STA to switch to the one or more frequency resources, wherein the communicating with the non-AP STA via the one or more frequency resources is based at least in part on the trigger frame.

Aspect 50: The method of any of aspects 29-49, wherein the communicating with the non-AP STA via the one or more frequency resources confirms the non-AP STA switched to the one or more frequency resources for the DSO session.

Aspect 51: The method of any of aspects 29-50, wherein the first frame comprises an NDP announcement frame.

Aspect 52: The method of aspect 51, further comprising: receiving a sounding NDP frame, a BFRP frame, a compressed beamforming feedback frame, or a combination thereof based at least in part on the NDP announcement frame, wherein the sounding NDP frame, the BFRP frame, the compressed beamforming feedback frame, or a combination thereof confirms the non-AP STA switched to the one or more frequency resources for the DSO session.

Aspect 53: The method of any of aspects 51-52, wherein the NDP announcement frame comprises a partial bandwidth information field of a STA information field corresponding to the non-AP STA, the partial bandwidth information field indicating the one or more frequency resources for the DSO session of the non-AP STA.

Aspect 54: The method of any of aspects 51-53, wherein the NDP announcement frame comprises MAC padding, a STA information field comprising a first value corresponding to padded content, an initial FCS prior to padding, or a combination thereof.

Aspect 55: The method of any of aspects 29-54, wherein the first frame comprises an eMBA frame.

Aspect 56: The method of aspect 55, wherein the eMBA frame comprises an AID field, an acknowledgment type field, a TID field, or a combination thereof indicating that the eMBA frame is associated with the DSO session; and the eMBA frame comprises a block acknowledgment starting sequence control field, a block acknowledgment bitmap field, or both indicating the one or more frequency resources for the DSO session of the non-AP STA.

Aspect 57: The method of any of aspects 29-56, wherein the first frame comprises a BAR frame.

Aspect 58: The method of aspect 57, wherein the BAR frame comprises a BAR type field indicating that the BAR frame is associated with the DSO session; and the BAR frame comprises a BAR information field indicating the one or more frequency resources for the DSO session of the non-AP STA.

Aspect 59: A non-AP STA, comprising a processing system that includes processor circuitry and memory circuitry that stores code, the processing system configured to cause the non-AP STA to perform a method of any of aspects 1-28.

Aspect 60: A non-AP STA for wireless communications, comprising at least one means for performing a method of any of aspects 1-28.

Aspect 61: A non-transitory computer-readable medium storing code for wireless communications, the code comprising instructions executable by one or more processors to perform a method of any of aspects 1-28.

Aspect 62: An AP STA, comprising a processing system that includes processor circuitry and memory circuitry that stores code, the processing system configured to cause the AP STA to perform a method of any of aspects 29-58.

Aspect 63: An AP STA for wireless communications, comprising at least one means for performing a method of any of aspects 29-58.

Aspect 64: A non-transitory computer-readable medium storing code for wireless communications, the code comprising instructions executable by one or more processors to perform a method of any of aspects 29-58.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A non-access point (AP) station (STA), comprising:
a processing system that includes processor circuitry and memory circuitry that stores code, the processing system configured to cause the non-AP STA to:
receive, via a primary subchannel associated with an AP STA, a first frame that indicates one or more frequency resources for a dynamic subchannel operation session of the non-AP STA, the one or more frequency resources included in at least one secondary subchannel associated with the AP STA;
communicate via the one or more frequency resources for a plurality of transmission opportunities in accordance with an activation of the dynamic subchannel operation session based at least in part on the first frame; and
communicate via the primary subchannel in accordance with a deactivation of the dynamic subchannel operation session based at least in part on a time-based trigger, a frame-based trigger, or both.

2. The non-AP STA of claim 1, wherein the processing system is further configured to cause the non-AP STA to:
receive an indication of a duration for operation in the dynamic subchannel operation session; and
switch to the primary subchannel for the communicating via the primary subchannel based at least in part on an expiration of the duration, wherein the time-based trigger comprises the duration.

3. The non-AP STA of claim 2, wherein the indication of the duration is received in the first frame, a management frame, a beacon frame, or a combination thereof.

4. The non-AP STA of claim 1, wherein the processing system is further configured to cause the non-AP STA to:
receive, via the one or more frequency resources, a second frame that indicates for the non-AP STA to switch back to the primary subchannel; and
switch to the primary subchannel for the communicating via the primary subchannel based at least in part on the second frame, wherein the frame-based trigger comprises the second frame.

5. The non-AP STA of claim 4, wherein the second frame indicates one or more second frequency resources for the non-AP STA, the one or more second frequency resources included at least partially in the primary subchannel.

6. The non-AP STA of claim 1, wherein the processing system is further configured to cause the non-AP STA to:
receive, via the one or more frequency resources, a second frame that indicates one or more second frequency resources for the dynamic subchannel operation session of the non-AP STA, the one or more second frequency resources included in at least one second secondary subchannel associated with the AP STA, the at least one second secondary subchannel different from the at least one secondary subchannel; and
switch to the one or more second frequency resources based at least in part on the second frame and the dynamic subchannel operation session at the non-AP STA.

7. The non-AP STA of claim 1, wherein the processing system is further configured to cause the non-AP STA to:
switch to the primary subchannel for the communicating via the primary subchannel prior to the time-based trigger; and
transmit, via the primary subchannel, a second frame to indicate the switching to the primary subchannel.

8. The non-AP STA of claim 1, wherein, to communicate via the one or more frequency resources for the plurality of transmission opportunities, the processing system is configured to cause the non-AP STA to:
receive one or more multi-user physical layer protocol data units;
transmit one or more trigger-based physical layer protocol data units; or both.

9. The non-AP STA of claim 1, wherein, to communicate via the one or more frequency resources for the plurality of transmission opportunities, the processing system is configured to cause the non-AP STA to:
monitor a portion of the at least one secondary subchannel for one or more physical layer protocol data units.

10. The non-AP STA of claim 9, wherein the processing system is further configured to cause the non-AP STA to:
receive an indication of static puncturing of the at least one secondary subchannel; and
switch to the primary subchannel for the communicating via the primary subchannel based at least in part on the indication of the static puncturing.

11. The non-AP STA of claim 1, wherein the first frame comprises an announcement frame, and the processing system is further configured to cause the non-AP STA to:
receive a second frame that triggers a switch to the one or more frequency resources, wherein the communicating via the one or more frequency resources is based at least in part on the second frame.

12. The non-AP STA of claim 1, wherein the first frame comprises a trigger frame that triggers a switch to the one or more frequency resources, wherein the communicating via the one or more frequency resources is based at least in part on the trigger frame.

13. The non-AP STA of claim 1, wherein the processing system is further configured to cause the non-AP STA to:
transmit a response frame confirming a switch to the one or more frequency resources for the dynamic subchannel operation session.

14. The non-AP STA of claim 1, wherein the communicating via the one or more frequency resources confirms a switch to the one or more frequency resources for the dynamic subchannel operation session.

15. An access point (AP) station (STA), comprising:
a processing system that includes processor circuitry and memory circuitry that stores code, the processing system configured to cause the AP STA to:
transmit, via a primary subchannel of the AP STA, a first frame that indicates one or more frequency resources for a dynamic subchannel operation session of a non-AP STA, the one or more frequency resources included in at least one secondary subchannel of the AP STA;
communicate with the non-AP STA via the one or more frequency resources for a plurality of transmission opportunities in accordance with an activation of the dynamic subchannel operation session at the non-AP STA based at least in part on the first frame; and
communicate with the non-AP STA via the primary subchannel in accordance with a deactivation of the dynamic subchannel operation session at the non-AP STA based at least in part on a time-based trigger, a frame-based trigger, or both.

16. The AP STA of claim 15, wherein the processing system is further configured to cause the AP STA to:
transmit an indication of a duration for operation in the dynamic subchannel operation session, wherein the time-based trigger comprises the duration.

17. The AP STA of claim 16, wherein, to transmit the indication of the duration, the processing system is configured to cause the AP STA to:
transmit a management frame indicating the duration for the operation in the dynamic subchannel operation session to a plurality of non-AP STAs comprising at least the non-AP STA.

18. The AP STA of claim 16, wherein the first frame comprises the indication of the duration.

19. The AP STA of claim 15, wherein the processing system is further configured to cause the AP STA to:
transmit, via the one or more frequency resources, a second frame that indicates for the non-AP STA to switch back to the primary subchannel, wherein the frame-based trigger comprises the second frame.

20. The AP STA of claim 19, wherein the second frame indicates one or more second frequency resources for the non-AP STA, the one or more second frequency resources included at least partially in the primary subchannel.

21. The AP STA of claim 15, wherein the processing system is further configured to cause the AP STA to:
transmit, via the one or more frequency resources, a second frame that indicates one or more second frequency resources for the dynamic subchannel operation session of the non-AP STA, the one or more second frequency resources included in at least one second secondary subchannel of the AP STA, the at least one second secondary subchannel different from the at least one secondary subchannel; and
communicate with the non-AP STA via the one or more second frequency resources for a second plurality of transmission opportunities based at least in part on the second frame and the dynamic subchannel operation session at the non-AP STA.

22. The AP STA of claim 15, wherein the processing system is further configured to cause the AP STA to:
receive, via the primary subchannel, a second frame indicating that the non-AP STA switched to the primary subchannel, wherein the communicating with the non-AP STA via the primary subchannel is based at least in part on the second frame.

23. The AP STA of claim 15, wherein, to communicate with the non-AP STA via the one or more frequency resources for the plurality of transmission opportunities, the processing system is configured to cause the AP STA to:
schedule one or more resources within the at least one secondary subchannel for communication with the non-AP STA while the dynamic subchannel operation session at the non-AP STA is active.

24. The AP STA of claim 15, wherein, to communicate with the non-AP STA via the one or more frequency resources for the plurality of transmission opportunities, the processing system is configured to cause the AP STA to:
transmit one or more multi-user physical layer protocol data units;
receive one or more trigger-based physical layer protocol data units; or both.

25. The AP STA of claim 15, wherein the first frame comprises an announcement frame, and the processing system is further configured to cause the AP STA to:
transmit a second frame for the non-AP STA to switch to the one or more frequency resources, wherein the communicating with the non-AP STA via the one or more frequency resources is based at least in part on the second frame.

26. The AP STA of claim 15, wherein the first frame comprises an announcement frame, and the processing system is further configured to cause the AP STA to:
determine to transmit a trigger frame for the non-AP STA based at least in part on an overlapping basic service set STA;
transmit the trigger frame for the non-AP STA to switch to the one or more frequency resources based at least in part on the determining; and
receive a response frame confirming the non-AP STA switched to the one or more frequency resources for the dynamic subchannel operation session based at least in part on the trigger frame.

27. The AP STA of claim 15, wherein the first frame comprises a trigger frame for the non-AP STA to switch to the one or more frequency resources, wherein the communicating with the non-AP STA via the one or more frequency resources is based at least in part on the trigger frame.

28. The AP STA of claim 15, wherein the communicating with the non-AP STA via the one or more frequency resources confirms the non-AP STA switched to the one or more frequency resources for the dynamic subchannel operation session.

29. A method for wireless communications at a non-access point (AP) station (STA), comprising:
receiving, via a primary subchannel associated with an AP STA, a first frame that indicates one or more frequency resources for a dynamic subchannel operation session of the non-AP STA, the one or more frequency resources included in at least one secondary subchannel associated with the AP STA;
communicating via the one or more frequency resources for a plurality of transmission opportunities in accordance with an activation of the dynamic subchannel operation session based at least in part on the first frame; and
communicating via the primary subchannel in accordance with a deactivation of the dynamic subchannel operation session based at least in part on a time-based trigger, a frame-based trigger, or both.

30. A method for wireless communications at an access point (AP) station (STA), comprising:
transmitting, via a primary subchannel of the AP STA, a first frame that indicates one or more frequency resources for a dynamic subchannel operation session of a non-AP STA, the one or more frequency resources included in at least one secondary subchannel of the AP STA;
communicating with the non-AP STA via the one or more frequency resources for a plurality of transmission opportunities in accordance with an activation of the dynamic subchannel operation session at the non-AP STA based at least in part on the first frame; and
communicating with the non-AP STA via the primary subchannel in accordance with a deactivation of the dynamic subchannel operation session at the non-AP STA based at least in part on a time-based trigger, a frame-based trigger, or both.
